(19) United States
(12) Patent Application Publication
(10) Pub. No.: US 2008/0189166 A1
(43) Pub. Date: Aug. 7, 2008

(54) Computer-based method of recommending modifications to residential or commercial property

(76) Inventor: Jay M. Brooks, Lafayette, LA (US)

Correspondence Address: Robert L. Waddell;PERRET DOISE, APLC, P.O. Drawer 3408, Lafayette, LA, 70502-3408, US

(21) Appl. No.: 11/701,345

(22) Filed: Feb. 1, 2007

(51) Int. Cl. G06F 17/27

(52) U.S. Cl. 705/10

(57) ABSTRACT

A computer-based method used by certified aging-in-place specialists and/or licensed medical professionals to evaluate and recommend universal, accessibility, adaptability, visitability and/or aging-in-place design modifications to residential or commercial property to satisfy independence, safety, and/or quality of life needs of an occupant of the property. The occupant may be a resident, care giver, or owner. The computer-based method employs a computer program that recommends the design modifications in response to specific environmental, disease, disability, or aging impairments of the occupant. The computer program is part of a wide area network accessible by a remote device such as a laptop computer, a tablet computer, or a hand-held computer via a secured Internet connection.

### FIELD OF THE INVENTION

The present invention relates to a computer-based method of recommending modifications to residential or commercial property and more particularly to a computer-based method of recommending modifications to residential or commercial property that is intended to satisfy a need of an occupant of the property such as the need for independence, safety, quality of life and/or aging-in-place.

### BACKGROUND OF THE INVENTION

In January 2011, ten thousand baby boomers in the United States will cross the threshold of retirement by turning 65. Every day thereafter, ten thousand more will cross this threshold until 2030 when there will be 80 million people over retirement age. A lack of accessible housing exists today for those of retirement age. In 25 years, where will the 80 million seniors live? Innovation to assist seniors has not kept up with demand. Accordingly, seniors have a difficult time getting the help they need to live in their own homes; they do not know where to turn for help.

A study by AARP found that more than 89% of people older than the age of 50 want to age in their own homes rather than move to assisted living facilities and nursing homes when their physical and cognitive capabilities begin to deteriorate. (Bayer & Harper 2000). The elderly are healthier and more financially secure than at any time in the past. And they are living longer. By 2050, the number of Americans over the age of 100 could be as high as 4,000,000. People in their 90's could number 8,000,000, and those in their 80's could exceed 20,000,000. (“Aging-in-place, Aging and the Impact of Interior Design,” 2000, American Society of Interior Designers). With increased longevity, there will be more people experiencing chronic health conditions that require regular assistance. Studies have shown that the elderly prefer home life and delivered care or assisted living. Many of the elderly will want to remain in their own homes or in the homes of family members. (“Fixing to Stay: A National Survey on Housing and Home Modifications Issues,” 2000 AARP). Because more people desire to remain in homes as they age, a specialty known as aging-in-place, has developed.

Aging-in-place refers to remaining in one's home safely, independently, and comfortably regardless of age, income, or ability level. A certified aging-in-place specialist is an individual who has completed a designated program by the National Association of Home Builders (NAHB) that teaches technical, business management, and customer service skills essential to competing in the residential remodeling industry for aging-in-place. The NAHB Remodelors Council, in collaboration with AARP, NAHB Research Center and NAHB Seniors Housing Council, developed the Certified Aging-in-place Specialist program to provide comprehensive, practical, market-specific information about working with older and maturing adults to remodel their homes for aging-in-place.

A Certified aging-in-place specialist/professional has been educated and experienced in:
(1) The principles of Universal Design (an approach that incorporates products and building features to be usable by all people to the greatest extent possible);
(2) The principles of Accessibility Design, which is the design of a space that allows a person with a disability to make the greatest possible use of space and targets a specific client with a disability;
(3) The principles of Adaptable Design, which is the design that addresses individual differences over time; it does not provide a high level of accessibility but does permit a space to be easily changed as needed;
(4) The principles of Aging-in-Place, which is a term used for people who want to live in their homes for as long as they are able to do so safely, independently, with a quality of life and peace of mind for the family members;
(5) The principles of Visitability, which is the design of a traditional home but has subtle changes in that the design permits a wheelchair user a minimum level of access to the ground floor of a home with wider doors, an entrance without steps, and at least one bathroom with sufficient turn space, and one bedroom on the main level.

Certified aging-in-place specialists/professionals are governed by five national standards for accessibility and are referenced in the following law:
(1) Veterans Administration Pamphlet 26-69-1, revised;
(2) ANSI A117.1—The American National Standards Institute “Specifications for Making Buildings and Facilities Accessible to and usable by Physically Disabled People”;
(3) UFAS—Uniform Federal Accessibility Standards for federal government compliance with Architectural Barriers Act of 1968 and Section 504 of the Rehabilitation Act of 1973;
(4) ADA—The American with Disabilities Act provides civil rights protection to people with disabilities and covers employment, transportation, communications, and accessibility to places of public accommodation. The ADA Accessibility Guidelines (ADAAG) cover the construction and alteration of both private sector (places of public accommodation and commercial facilities), and the public sector (state and local government); and
(5) The Fair Housing Act of 1968, as amended in 1988.

Most certified aging-in-place specialists are builders or remodelors. Many, however, are increasingly general contractors, designers, architects, licensed medical clinicians, and healthcare consultants.

Occupational therapy is an applied science and health profession that provides skilled treatment to help individuals develop, regain, or maintain the skills necessary for independent and satisfying lives. Occupational therapists evaluate the person, the person's environment, and the person's occupational performance in that environment, and based on the evaluation, recommend products and/or therapeutic treatments to improve the fit between the person, place, and activity. Occupational therapy includes: (1) customized treatment programs to improve one's ability to perform daily activities; (2) comprehensive home and job site evaluations with adaptations recommendations; (3) performance skills assessments and treatments; (4) adaptive equipment recommendations and usage training; and (5) guidance to family members and care givers.

Individuals that benefit from occupational therapy include but are not limited to those with: (1) work-related injuries including lower back problems or repetitive stress injuries; (2) limitations following a stroke or heart attack; (3) arthritis, multiple sclerosis, or other serious chronic conditions; (4) birth injuries, learning problems or developmental disabilities; (5) mental health or behavioral problems including Alzheimer's, schizophrenia, and post-traumatic stress; (6) problems with substance use or eating disorders; (7) burns, spinal cord injuries, or amputations; (8) broken bones or other injuries from falls, sports injuries, or accidents; and (9) vision or cognitive problems that threaten the ability to drive or to perform other life skills.

As stated above, occupational therapy may involve home evaluations and adaptation recommendations. For home evaluations, the occupational therapist assesses needs, identifies solutions, implements solutions, functional tasks, trains in the use of solutions, and evaluates outcomes that contribute to home modification. The recommendations can include alterations, adjustments, or additions to the home environment through the use of specialized, customized, off-the-shelf, or universally designed technologies, equipment, products, hardware controls, finishes, furnishings, and other features that affect the layout and structure of the home. Home evaluations have become particularly important because people are living longer and desire to remain in their homes for as long as they can.

The present invention uses the combined skills of occupational therapy and certified aging-in-place as part of a unique method of recommending modifications to residential property to satisfy a need of an occupant (e.g., resident, care giver, visitor) such as the need for independence, safety, quality of life and/or aging-in-place. The present invention also uses the combined skills of occupational therapy and certified aging-in-place as part of a unique method of recommending modifications to commercial property to satisfy a need of an occupant (owner, employee, or invitee) and to comply with federal legislation and federal accessibility laws, codes, and standards such as:
(1) The American with Disabilities Act (ADA) (1990), which compliance is primarily overseen by the Department of Justice (DOJ);
(2) Program Accessibility, (ADA Title II) of the Americans with Disabilities Act Accessibility Guidelines (ADAAG);
(3) Removal of Barriers, (ADA Title III) of the American with Disabilities Act (ADA); and
(4) Fair Housing Amendment Act and Fair Housing Accessibility Guidelines, which require that all public accommodations be accessible to people with disabilities.

### SUMMARY OF THE INVENTION

It is an object of the present invention to provide a novel method for recommending modifications to residential or commercial property that is computer based and easy to use.

It is a further object of the present invention to provide a novel method for recommending modifications to residential or commercial property that is computer based and integrates tools associated with occupational therapy and certified aging-in-place.

It is a further object of the present invention to provide a novel method for recommending modifications to residential or commercial property that is computer based and specific to a disease, disability, or impairment of an occupant of the property.

The objects and advantages of the present invention are achieved by providing a novel method of recommending modifications to residential or commercial property. An embodiment of the method of the present invention involves evaluating and collecting data about the accessibility, safety, and functionality of a residential property and evaluating and collecting data about the current and projected future physical capabilities and medical health of an occupant of the residential property. All of the data collected is inputted into a computer program. The computer program generates a recommendation to modify the residential property in response to the inputted collected data. The recommendation is intended to satisfy a need of the occupant. The need may be independence, safety, quality of life and/or aging-in-place initiatives.

The data about accessibility of the residential property may include information about environmental barriers that prevent or restrict the occupant from maneuvering within the residential property. The data about safety may include information about the ability of the occupant to perform functional tasks within the residential property without causing harm to the occupant (e.g., a resident of the residential property, a care giver providing assistance to the resident, or a person visiting the resident or care giver). The data about the functionality of the residential property may include information about the physical environment of the residential property and the ability of the occupant to effectively use the physical environment. The physical environment may include structure, accessibility to the structure, floor plan, accessible pathways, appliances, major mechanical and environmental equipment, furniture, lighting and plumbing fixtures, floors, walls, ceiling, doors, windows, cabinets and countertops, flooring, or any combination thereof,

The evaluation and collection of data about the accessibility, safety and functionality of the residential property may be undertaken by a certified aging-in-place specialist, a licensed medical professional, or both. The certified aging-in-place specialist may be a professional remodelor, a licensed contractor, a licensed medical professional, a licensed interior designer, or a licensed professional involved with housing for disabilities, products, accessibility, and aging. The licensed medical professional may be an occupational therapist, an occupational therapist assistant, a physical therapist, a physical therapist assistant, a registered nurse, or a licensed practical nurse.

The evaluation and collection of data about the current and projected future physical capabilities and medical health of the occupant may be undertaken by a licensed medical professional, who may be an occupational therapist, an occupational therapist assistant, a physical therapist, a physical therapist assistant, a registered nurse, or a licensed practical nurse.

The residential property may include a residence having an interior and an exterior. The residential property may also include grounds surrounding or adjacent to the residence. The data collected about the accessibility, safety, and functionality of the residential property may include data about the accessibility, safety, and functionality of the interior of the residence, the exterior of the residence, the grounds of the residential property, or any combination thereof.

The data collected about the accessibility, safety, and functionality of the interior of the residence may include information about primary entrance doors; foyers; hallways; living rooms; dining rooms; interior stairs including stairs to basement, upper levels, and attic; ramps; lifts; elevators; windows; decks; balconies; porches; Heating/Venting/Air Conditioning (HVAC); kitchens; cabinets and countertops; appliances; bedrooms; separate apartments; offices; flex rooms such as mini-hospital rooms; hall and guest bathrooms; entertainment rooms; family rooms; dens; bath tubs; showers; vanities; utility, laundry, and mudrooms; storage; storage areas; trashcans; grab bars and railings; flooring; pathways to all areas; space planning; house plans and designs; steps; split levels; stairwells; personal emergency responses; electrical, lighting, safety and security, environmental controls; storage; heights of breaker/fuse boxes; garage, car port and boarding spaces; surfaces and flooring in garage, car port, and boarding spaces; utility, laundry, mudroom and bathroom cabinets; closets; convenience features such as central vacuum, built-in pet feeder, built-in recycling system, video phone or camera, and intercom system; width of hallways and doorways; doors, hardware, and cabinet fixtures; plumbing faucet and fixtures; basement and attic accessibility; lighting; colors and contrasts for walls, finishes, and insulation; emergency escape routes; or any combination thereof.

The data collected about the accessibility, safety, and functionality of the exterior of the residence may include information about protected or covered entryways, sidewalks, steps, porches, decks, handrails, hardware, ramps, exterior lighting, emergency response systems, or any combination thereof.

The data collected about the accessibility, safety, and functionality of the grounds of the residential property may include information about parking, walkways, driveways, gardens, pathways, seating areas, lighting, maintenance, security, storage sheds or outbuildings, irrigation, landscaping, swimming pools, patio furniture, outdoor kitchens, accessible routes, mailboxes or mail chutes, surfaces, steps, railways, ramps, lifts, or any combination thereof.

The data collected about the current and projected future physical abilities and medical health of the occupant of the residential property may include information about age; medical history; functional tasks; functional mobility; medication use including use of diuretics, narcotics, and pain relievers; hand dexterity; fall prevention; range of motion; sensory skills; endurance; mental health; progression of disease; vision; hearing; cognitive ability; olfactory capabilities; balance; strength; functional communication; or any combination thereof.

The data collected about the accessibility, safety, and functionality of the residential property may include a visual presentation. The visual presentation may be a digital photograph or a digital video.

The computer program may be activated to generate a recommendation to modify the residential property. The recommendation is intended to satisfy a need of the occupant such as the need for safety, independence, quality of life, and/or aging-in-place initiatives. The recommendation may also include a phased design for the residential property that provides for future modifications intended to satisfy a long-term need of the occupant. The long-term need may be the need for safety, independence, quality of life, aging-in-place initiatives, or any combination thereof.

The recommendation may include a recommendation to physically modify the residential property. The physical modification may include adding, removing, or modifying pathways; landscaping; gardens; mailboxes; trashcan placement areas; surfaces; entranceways; hallways; ramps; stairs; porches; decks; split levels; lifts; cabinets; appliances; furniture; lighting; wall and cabinet colors; flooring; controls for lighting, heating, venting, air conditioning, disposals; toilets; fixtures for plumbing and faucets; sinks; tubs; showers; bidets; bedrooms; storage areas; communication devices; a tele-health and tele-medicine area or room; mini-hospital room; elevators; grab bars; railings; door hardware; smoke and alarm detectors; or any combination thereof.

The recommendation to modify the residential property may also include the identification of a product to be incorporated into the residential property as part of the physical modification. The product so identified may be a pathway surface; light fixture; photo sensor; mailbox; ramp; lift; cabinet; appliance; furniture; flooring; carpeting; contrast surfaces; controls for lighting, heating, venting air conditioning, or disposal; electric outlet; toilet; fixtures for plumbing and faucets; sink; tub; shower; bidet; bedroom, office cabinets or equipment; storage area; shelving for garden tools; tele-health or tele-medicine area or room; mini-hospital equipment; elevator; grab bar; railing; door hardware; or smoke or alarm detector.

The recommendation to modify the residential property may also include an identification of a product to be used by the occupant. The product so identified may be a communication device; utensil; wheel chair; power chair; transfer board; hoyer lift; trapeze bar; walker; cane; vertical support pole; grab bar; oxygen tank or machine; care monitoring system; home entertainment system; emergency preparedness container, or other durable medical equipment product.

The recommendation generated by the computer program to modify the residential property may include a visual presentation. The visual presentation may be a digital photograph or digital video.

In this embodiment of the method of the present invention, the occupant may be a resident of the residential property, a care giver providing assistance to a resident of the residential property, or an owner of the residential property.

The computer program may be part of a wide-area network that is accessible by Internet connection. The wide-area network may be a wide-area wireless network. The computer program may be stored on a central server that is accessible by a remote device preferably via a web-based wireless network. The remote device may be used to input the collected data into the computer program. More than one remote device may be used. The remote device may be a laptop computer, a tablet computer, or a hand-held computer. Preferably, the remote device is operable by a stylus that is used to input collected data into the computer program or otherwise operate the remote device. The computer program is part of a secured computer system with all data transferred via the Internet being encrypted.

The recommendation generated by the computer program may be presented to the occupant by displaying the recommendation on the remote device. The recommendation may also be transmitted to a third person such as a contractor, subcontractor, healthcare professional, immediate family member or designated contact person for the occupant, insurance carrier, or government agency.

This embodiment of the method of the present invention may also include presenting the recommendation to modify the residential property to the occupant by printing a paper copy of the recommendation and displaying the paper copy to the occupant. Preferably, the remote device is connected to a printer which prints the paper copy of the recommendation.

This embodiment of the method of the present invention may include the step of obtaining a laser beam measurement of the residential property and inputted the measurement into the computer program. The computer program generates a floor plan for the residential property in response to the inputted measurement. Preferably, the measurement and the floor plan are included in the recommendation to modify the residential property.

The method of the present invention may also include the step of inputting a further or separate recommendation directly into the computer program. The recommendation may be directly inputted into the computer program by word-processing, writing capture, or voice capture.

In this embodiment of the method of the present invention, the residence may be a single-family home, a multi-family home, an assisted-living facility, or a nursing home.

The method of the present invention may also include the step of causing the computer program to generate a clinical recommendation for therapeutic intervention of the occupant. The clinical recommendation may be a recommendation for rehabilitative therapy protocol, a recommendation to schedule an appointment with a primary care physician, or both.

The computer program contains a database. The database includes collected data inputted into the computer program and the recommendation generated by the computer program. The database may be searched and specific information such as the collected data and/or recommendations may be retrieved. To assist in the search and retrieval of the collected data and recommendation, the computer program contains a search facilitator. The search facilitator may be a key word, category of information, 3-D floor plan, or any combination thereof.

The computer program also may contain screen prompts. The screen prompts may be used to collect data about the accessibility, safety, and functionality of the residential property and/or collect data about the current and projected future medical health of the occupant. The screen prompts may identify specific information to be evaluated, collected, and inputted into the computer program so as to generate the recommendation to modify the residential property.

One of the unique features of this embodiment of the method of the present is the capability of the computer program to generate a recommendation that includes an option to modify the residential property in response to designating a specific disease, impairment, or disability of the occupant within the computer program. Such specific disease, impairment or disability may include Arthritis, Alzheimer's, Amputation, Dementia, Diabetes, Heart Disease, Joint Replacement, Low Vision or Blindness, Paralysis, Parkinson's, Stroke, Risk of Falls, Range of Motion, Multiple Sclerosis, and Down's Syndrome.

In another embodiment of the method of the present invention, a computer program generates a recommendation to modify a commercial property. The recommendation is intended to satisfy a need of an occupant of the commercial property. This embodiment involves evaluating and collecting data about the accessibility, safety, and functionality of the commercial property. The collected data is inputted into a computer program. The computer program is activated to generate a recommendation to modify the commercial property in response to the included collected data. The recommendation is intended to satisfy a need of the occupant. The need may be independence, safety, quality of life, or any combination thereof.

The evaluation and collection of data about the accessibility, safety, and functionality of the commercial property may be undertaken by a certified aging-in-place specialist, a licensed medical professional, or both. The certified aging-in-place specialist may be a professional remodelor, a licensed contractor, a licensed interior designer, and a licensed professional involved with housing for disabilities, products, accessibility, and aging. The licensed medical professional may be an occupational therapist, an occupational therapist assistant, a physical therapist, a physical therapist assistant, a registered nurse, or a licensed practical nurse.

This embodiment of the method of the present invention may also include the steps of evaluating and collecting data about the current and projected future physical capabilities and medical health of the occupant of the commercial property. The data collected about the current and projected future physical capabilities and medical health of the occupant may be inputted into the computer program and the computer program activated to generate a recommendation to modify the commercial property in response to the inputted data. The recommendation is intended to satisfy the need of the occupant.

The evaluation and collection of data about the current and projected future physical capabilities and medical health of the occupant of the commercial property may be undertaken by a licensed medical professional. The licensed medical professional may be an occupational therapist, an occupational therapist assistant, a physical therapist, a physical therapist assistant, a registered nurse, or a licensed practical nurse.

The data collected about the current and projected future physical capabilities and medical health of the occupant may include information about age; medical history; functional tasks; functional mobility; medication use including use of diuretics, narcotics, and pain relievers; hand dexterity; fall prevention; range of motion; sensory skills; endurance; mental health; progression of disease; vision; hearing; cognitive ability; olfactory capabilities; balance; strength; functional communication; or any combination thereof.

The data collected about the accessibility, safety, and functionality of the commercial property may also include information about needs for alterations, additions, program accessibility, essential and non-essential job functions, cosmetic work, maintenance repairs, transitions, specialized equipment, products or information, renovation, remodel modifications, targeting existing problem areas or architectural inefficiencies, plan review to eliminate costly structural changes or endorse specialized modifications for safety, prolonging the independence in the work place, quality of work styles, rearranging existing work spaces, or any combination thereof.

The data collected about accessibility, safety, and functionality of the commercial property may also include information about continuous path of travel, surface material, slope and cross-slope, curb ramp design and locations, on-street parking, alternate circulation path, islands and medians, pedestrian button location and design, accessibility of pedestrian signals, street or patio furniture style, access and placement; drinking fountains, illumination of pathways, handrails, parking spaces; warning for hearing impaired including clear signage, symbols and pictograms, clear sightlines, audible information systems louder than ambient surrounding noise; existing barriers and list physical barriers that limit accessibility, programs, activities, or services; warning for low vision including hazards of protruding objects, symbols and pictograms, blended curbs, detectable warnings, audible information systems, tactical information systems, visual contrast at steps, visual cues, wall mounts and post mounted objects; adequate shelter from weather in passenger unloading zone; entrance ramps and hand rails; width of doorways, door openers, electronic pad for security card entry, special access lifts; unobstructed routes through facility; accessible restrooms including slippery walking or hygiene issues insufficient maneuvering area, controls, toilet height, stall width, grab bar combinations, inadequate storage shelf in stall and or inaccessible places, door landings, latch side clearance, signage to identify permanent rooms and space, lighting, faucets, bank of telephones, or any combination thereof.

The recommendation to modify the commercial property may include a recommendation for accessibility by developing guidelines for new or altered facilities covered under the Americans with Disabilities Act (ADA) and/or the Architectural Barrier Act (ABA).

It is preferred that the need of the occupant intended to be satisfied by the recommendation to modify the commercial property include the enhancement of the occupant's accessibility, the elimination of obstacles for community involvement, the improvement of work place ergonomics for increasing quality of work styles, the promotion of environmental harmony in designing for accessible communities, or any combination thereof.

The data collected about the accessibility, safety, and functionality of the commercial property may include a visual presentation. The visual presentation may be a digital photograph or a digital video.

The recommendation to modify the commercial property may include a recommendation to physically modify the commercial property. The recommendation to modify the commercial property may also include identifying a product to be incorporated into the commercial property as part of the physical modification. The recommendation to modify the commercial property may also include the identification of a product to be used by the occupant.

The recommendation generated by the computer program in response to the inputted collected data may include a visual presentation. The visual presentation may be a digital photograph or a digital video.

In this embodiment of the present invention, the occupant may be an invitee to the commercial property, an employee working at the commercial property, or an owner of the commercial property, or a legal representative of the owner.

The computer program may be part of a wide-area network that is accessible by Internet connection. The wide-area network may be a wide-area wireless network. The computer program may be stored on a central server which is accessible by a remote device preferably via a web-based wireless network. The remote device may be used to input the collected data into the computer program. More than one remote device may be used. The remote device may be a laptop computer, a tablet computer, or a hand-held computer. Preferably, the remote device is operable by a stylus that is used to input collected data into the computer program or otherwise operate the remote device. The computer program is preferably part of a secured computer system with all data transferred via the Internet being encrypted.

This embodiment of the present invention may also include the step of presenting the recommendation to modify the commercial property to the occupant by displaying the recommendation on the remote device. The method may also include the step of transmitting the recommendation to modify the commercial property to a third-person. The third-person may be a contractor, subcontractor, healthcare professional, designated contact person for the occupant, insurance carrier, or government agency.

This embodiment of the method of the present invention may also include presenting the recommendation to modify the commercial property to the occupant by printing a paper copy of the recommendation and displaying the paper copy to the occupant. Preferably, the remote device is connected to a printer which prints the paper copy of the recommendation.

In an alternative method of this embodiment of the present invention, a laser beam measurement is obtained of the commercial property and the inputted into the computer program. The computer program generates a floor plan for the commercial property in response to the inputted measurement. Preferably, the measurement and the floor plan are included in the recommendation to modify the commercial property.

This embodiment of the present invention may also include the step of inputting a further or separate recommendation to modify the commercial property directly into the computer program. The further or separate recommendation may be inputted into the computer program via word processing, writing capture, or voice capture.

In this embodiment of the present invention, the commercial property is preferably an office building; public or private school, university, or college; medical professional building; restaurant; hotel; motel; commercial facility; resort; or VA, public, or private hospital.

The computer program contains a database. The database includes collected data inputted into the computer program and the recommendation generated by the computer program. The database may be searched and specific information such as the collected data and/or recommendations may be retrieved. To assist in the search and retrieval of the collected data and recommendation, the computer program contains a search facilitator. The search facilitator may be a key word, category of information, 3-D floor plan, or any combination thereof.

The computer program also may contain screen prompts. The screen prompts may be used to collect data about the accessibility, safety, and functionality of the commercial property and/or collect data about the current and projected future medical health of the occupant. The screen prompts may identify specific information to be evaluated, collected, and inputted into the computer program so as to generate the recommendation to modify the commercial property.

In summary, the computer program used as part of the method of the present invention is for the residential/commercial evaluation of: (1) accessibility to the physical environment by the occupant; (2) modifications/renovations needed (including the nature and magnitude of the modifications/renovations needed) to increase accessibility to the physical environment; (3) occupant's ability to perform activities of daily living and/or work tasks (commercial) within the physical environment. The client (e.g., occupant) will receive the following: (1) report of existing problems noted in regards to both the occupant's abilities and the physical environment; (2) individualized clinical assessment of the occupant's physical abilities/disabilities, ability to complete functional tasks within the context of their current diagnosis/condition and within the context of their current physical environment; (3) report of recommended solutions to the problems noted; (4) report of specific recommendations (in the form of products to meet the recommended solutions noted above).

The evaluation will develop a written assessment to determine: (1) specific illnesses and disabilities, and diseases as well as aging-in-place environmental initiatives and assessments will be offered in a process for linking human disabilities (and age related ailments) to specific areas of a home (and other areas occupied or used by the occupants) to generate a wireless and/or written assessment to determine the function, outcome, treatment plan and recommendation with options for products, interventions, and environmental modifications useful in enhancing safety, prolonging independence, quality of life and the aging-in-place/peace of mind solutions.

Medical and aging-in-place specialists know it is extremely important to be able to tactfully and knowledgeably discuss a client's medical situation and prognosis (as it relates to their “Functional Abilities,” not their medical condition). For example, a client who is presently ambulatory but who has a progressive-type illness (the beginnings of Parkinson's disease) can accept an evaluation for “Phased Design”; providing for future wheelchair use, ergonomic design to reduce fatigue and allow for energy conservation and task lighting.

The computer program is wired or wireless and is a pin/web-based mobile evaluation online communications hub with a database query and relations table warehouse. Details of up-to-date products, equipment and digital imaging will form the operating systems. The program will capture laser beam measurements for detailed floor plans with notification directly to all professionals that the evaluation is relevant to. The professional completing the evaluation will have available to him the ability to pull down various reports such as: final copy of evaluation requested by client, future recommendations for the client, areas of concern noted with possible solutions, equipment recommendations. The evaluation may include photos of exterior of residence, photos of client, photos of client with spouse, video of client entering residence.

### BRIEF DESCRIPTION OF THE DRAWINGS

FIG. 1 is a flow chart depicting the steps used in practicing the embodiment of the method of the present invention for recommending modifications to residential property.

FIG. 2 is a chart depicting the components of the data constituting accessibility, safety, and functionality that are evaluated and collected in the embodiment of the method of the present invention for recommending modifications to residential property.

FIG. 3 is a chart depicting the components of the residential property in the embodiment of the method of the present invention for recommending modifications to residential property.

FIG. 4 is a chart depicting that the data collected concerning the residential property in the embodiment of the method of present invention for recommending modifications to residential property includes visual presentations.

FIG. 5 is a chart depicting that in the method of the present invention for modifying residential property, the recommendation may include a phased design recommendation.

FIG. 6 is a chart depicting the components and presentation styles of the recommendation generated in the embodiment of the method of the present invention for recommending modifications to residential property.

FIG. 7 is a chart depicting the computer system used in the embodiment of the method of the present invention for recommending modifications to residential property.

FIG. 8 is a chart depicting the step of presenting the recommendation that may be part of the embodiment of the method of the present invention for recommending modifications to residential property.

FIG. 9 is a chart depicting the step of transmitting the recommendation that may be part of the embodiment of the method of the present invention for recommending modifications to residential property.

FIG. 10 is a chart depicting the step of generating a flow chart that may be part of the embodiment of the method of the present invention for recommending modifications to residential property.

FIG. 11 is a chart depicting the step of directly inputting a recommendation that may be part of the embodiment of the method of the present invention for recommending modifications to residential property.

FIG. 12 is a chart depicting the step of generating a clinical recommendation that may be part of the embodiment of the method of the present invention for recommending modifications to residential property.

FIG. 13 is a chart depicting the step of searching and retrieving data stored in the computer program that may part of the embodiment of the method of the present invention for recommending modifications to residential property.

FIG. 14 is a chart depicting the use of screens prompts to collect and input data into the computer program that may be part of the embodiment of the method of the present invention for recommending modifications to residential property.

FIG. 15 is a chart depicting the step of generating an option to modify residential property in response to a specific disease, impairment, or disability of the occupant that may be part of the embodiment of the method of the present invention for recommending modifications to residential property.

FIG. 16 is a flow chart depicting the steps used in practicing the embodiment of the method of the present invention for recommending modifications to commercial property.

FIG. 17 is a flow chart depicting the steps of evaluating and collecting data, inputting collected data, and generating a recommendation based on information about an occupant that may be part of the embodiment of the method of the present invention for recommending modifications to commercial property.

FIG. 18 is a chart depicting that the data collected concerning the commercial property in the embodiment of the method of present invention for recommending modifications to commercial property includes visual presentations.

FIG. 19 is a chart depicting the components and presentation styles of the recommendation generated in the embodiment of the method of the present invention for recommending modifications to commercial property.

FIG. 20 is a chart depicting the computer system used in the embodiment of the method of the present invention for recommending modifications to commercial property.

FIG. 21 is a chart depicting the step of presenting the recommendation that may be part of the embodiment of the method of the present invention for recommending modifications to commercial property.

FIG. 22 is a chart depicting the step of transmitting the recommendation that may be part of the embodiment of the method of the present invention for recommending modifications to commercial property.

FIG. 23 is a chart depicting the step of generating a floor plan that may be part of the embodiment of the method of the present invention for recommending modifications to commercial property.

FIG. 24 is a chart depicting the step of directly inputting a recommendation that may be part of the embodiment of the method of the present invention for recommending modifications to commercial property.

FIG. 25 is a chart depicting the step of searching and retrieving data stored in the computer program that may part of the embodiment of the method of the present invention for recommending modifications to commercial property.

FIG. 26 is a chart depicting the use of screens prompts to collect and input data into the computer program that may be part of the embodiment of the method of the present invention for recommending modifications to commercial property.

FIG. 27 is an exemplar of a screen print from the computer program that may be used as part of the method of the present invention.

FIG. 28 is a further exemplar of a screen print from the computer program that may be as part of the method of the present invention.

### DETAILED DESCRIPTION OF THE PREFERRED EMBODIMENTS

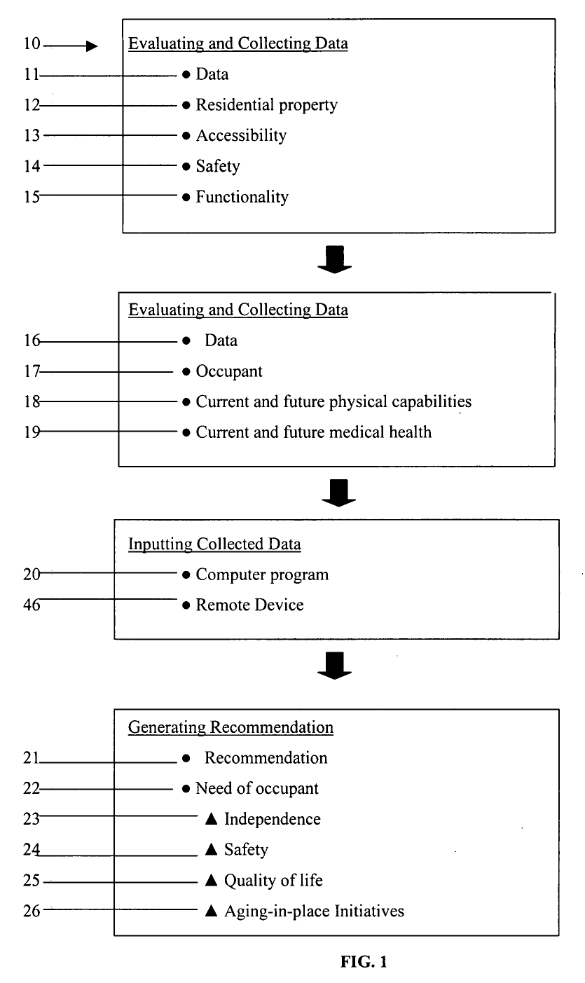

With reference to the figures where like elements have been given like numerical designation to facilitate an understanding of the present invention, and particularly with reference to the embodiment of the method of the present invention illustrated in FIG. 1, method 10 involves evaluating and collecting data 11 about accessibility 13, safety 14, and functionality 15 of residential property 12. Method 10 also involves evaluating and collecting data 16 about current and projected future physical capabilities 18 and medical health 19 of occupant 17 of residential property 12. Collected data 11, 16 is inputted into computer program 20. Computer program 20 generates recommendation 21 to modify residential property 12 in response to inputted collected data 11, 16. Recommendation 21 is intended to satisfy need 22 of occupant 17. Need 22 may be independence 23, safety 24, quality of life 25, aging-in-place initiatives 26, or any combination thereof. Occupant 17 may be a resident of residential property 12, a care giver providing assistance to a resident of residential property 12, or an owner of residential property 12.

Table 1 appended hereto provides an example of the application of computer program 20 to assist in the evaluation and collection of data 11, 16 and the generation of recommendation 21 to modify residential property 12 in response to inputted collected data 11, 16.

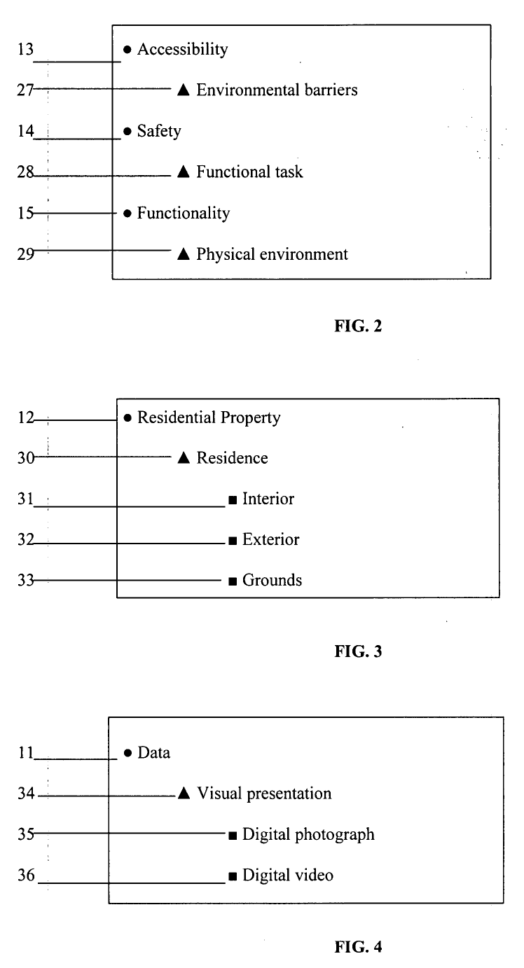

As shown in FIG. 2, collected data 11 about accessibility 13 of residential property 12 may include information about environmental barriers 27 that prevent or restrict occupant 17 from maneuvering within residential property 12. Collected data 11 about safety 14 may include information about the ability of occupant 17 to perform functional tasks 28 within residential property 12 without causing harm to occupant 12 (e.g., a resident of residential property 12, a care giver providing assistance to the resident, or a person visiting the resident or care giver). Collected data 11 about functionality 15 of residential property 12 may include information about physical environment 29 of residential property 12 and the ability of occupant 12 to effectively use physical environment 29. Physical environment 29 may include structure, accessibility to the structure, floor plan, accessible pathways, appliances, major mechanical and environmental equipment, furniture, lighting and plumbing fixtures, floors, walls, ceiling, doors, windows, cabinets and countertops, flooring, or any combination thereof.

Functional tasks include, for example, the ability of occupant 17 to enter residential property 12 unaided or with a durable medical equipment (DME) such as a cane, walker, wheelchair, or scooter; the ability of occupant 17 to access the entrance way such as opening and closing doors, locking and unlocking doors, the ability of occupant 17 to move over the flooring unaided or with a DME; the ability of occupant 17 to engage in personal hygiene such as shaving, make-up, oral care, hair styling, grooming, wash hands at sink, bathing, showering; the ability of occupant 17 to engage in toilet hygiene such as transfer to and from the toilet; and/or the ability of occupant 17 to engage in clothing management.

The evaluation and collection of data 11 about accessibility 13, safety 14, and functionality 15 of residential property 12 may be undertaken by a certified aging-in-place specialist, a licensed medical professional, or both. The certified aging-in-place specialist may be a professional remodelor, a licensed contractor, a licensed medical professional, a licensed interior designer, or a licensed professional involved with housing for disabilities, products, accessibility, and aging. The licensed medical professional may be an occupational therapist, an occupational therapist assistant, a physical therapist, a physical therapist assistant, a registered nurse, or a licensed practical nurse.

The evaluation and collection of data 11 about current and projected future physical capabilities 18 and medical health 19 of occupant 17 may be undertaken by a licensed medical professional, who may be an occupational therapist, an occupational therapist assistant, a physical therapist, a physical therapist assistant, a registered nurse, or a licensed practical nurse.

With reference to FIG. 3, residential property 12 may include residence 30 having an interior 31 and exterior 32. Residential property 12 may also include grounds 33 surrounding or adjacent to residence 30. Collected data 11 about accessibility 13, safety 14, and functionality 15 of residential property 12 may include data 11 about accessibility 13, safety 14, and functionality 15 of interior 31 of residence 30, exterior 32 of residence 30, grounds 33 of residential property 12, or any combination thereof. Residence 30 may be a single-family home, a multi-family home, an assisted-living facility, or a nursing home.

Collected data 11 about accessibility 13, safety 14, and functionality 15 of interior 31 of residence 30 may include information about primary entrance doors; foyers; hallways; living rooms; dining rooms; interior stairs including stairs to basement, upper levels, and attic; ramps; lifts; elevators; windows; decks; balconies; porches; Heating/Venting/Air Conditioning (HVAC); kitchens; cabinets and countertops; appliances; bedrooms; separate apartments; offices; flex rooms such as mini-hospital rooms; hall and guest bathrooms; entertainment rooms; family rooms; dens; bath tubs; showers; vanities; utility, laundry, and mudrooms; storage; storage areas; trashcans; grab bars and railings; flooring; pathways to all areas; space planning; house plans and designs; steps; split levels; stairwells; personal emergency responses; electrical, lighting, safety and security, environmental controls; storage; heights of breaker/fuse boxes; garage, car port and boarding spaces; surfaces and flooring in garage, car port, and boarding spaces; utility, laundry, mudroom and bathroom cabinets; closets; convenience features such as central vacuum, built-in pet feeder, built-in recycling system, video phone or camera, and intercom system; width of hallways and doorways; doors, hardware, and cabinet fixtures; plumbing faucet and fixtures; basement and attic accessibility; lighting; colors and contrasts for walls, finishes, and insulation; emergency escape routes; or any combination thereof.

Collected data 11 about accessibility 13, safety 14, and functionality 15 of exterior 32 of residence 30 may include information about protected or covered entryways, sidewalks, steps, porches, decks, handrails, hardware, ramps, exterior lighting, emergency response systems, or any combination thereof.

Collected data 11 about accessibility 13, safety 14, and functionality 15 of grounds 33 of residential property 12 may include information about parking, walkways, driveways, gardens, pathways, seating areas, lighting, maintenance, security, storage sheds or outbuildings, irrigation, landscaping, swimming pools, patio furniture, outdoor kitchens, accessible routes, mailboxes or mail chutes, surfaces, steps, railways, ramps, lifts, or any combination thereof.

Collected data 11 about current and projected future physical abilities 18 and medical health 19 of occupant 17 of residential property 12 may include information about age; medical history; functional tasks; functional mobility; medication use including use of diuretics, narcotics, and pain relievers; hand dexterity; fall prevention; range of motion; sensory skills; endurance; mental health; progression of disease; vision; hearing; cognitive ability; olfactory capabilities; balance; strength; functional communication; or any combination thereof.

FIG. 4 illustrates that collected data 11 about accessibility 13, safety 14, and functionality 15 of residential property 12 may include visual presentation 34. Visual presentation 34 may be digital photograph 35 or digital video 36. Digital photograph 35 and/or digital video 36 may portray residential property 12 and/or occupant 17. More than one visual presentation 34 (e.g., digital photograph 35 and/or digital video 36) may be part of collected data 11. Visual presentation 34 may include floor plan 104.

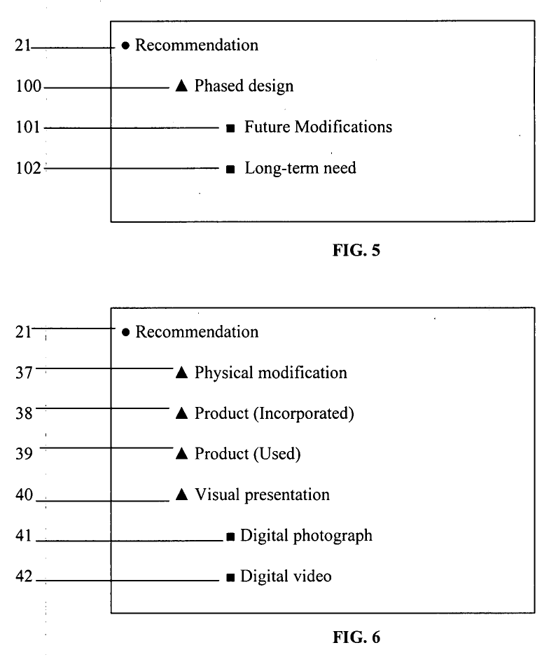

With reference to FIG. 5, recommendation 21 generate by computer program 20 may include phased design 100 for modification of residential property 12. Phased design 100 provides future modifications to residential property 12 that are intended to satisfy long-term need 102 of occupant 17. Long-term need 102 may also be a need for independence 23, safety 24, quality of life 25, aging-in-place initiatives 26, or any combination thereof.

FIG. 6 reveals that recommendation 21 may include a recommendation for physical modification 37 of residential property 12. Physical modification 37 may include adding, removing, or modifying pathways; landscaping; gardens; mailboxes; trashcan placement areas; surfaces; entranceways; hallways; ramps; stairs; porches; decks; split levels; lifts; cabinets; appliances; furniture; lighting; wall and cabinet colors; flooring; controls for lighting, heating, venting, air conditioning, disposals; toilets; fixtures for plumbing and faucets; sinks; tubs; showers; bidets; bedrooms; storage areas; communication devices; a tele-health and tele-medicine area or room; mini-hospital room; elevators; grab bars; railings; door hardware; smoke and alarm detectors; or any combination thereof.

Again with reference to FIG. 6, recommendation 21 to modify residential property 12 may also include the identification of product 38 to be incorporated into residential property 12 as part of physical modification 37. Product 38 may be a pathway surface; light fixture; photo sensor; mailbox; ramp; lift; cabinet; appliance; furniture; flooring; carpeting; contrast surfaces; controls for lighting, heating, venting air conditioning, or disposal; electric outlet; toilet; fixtures for plumbing and faucets; sink; tub; shower; bidet; bedroom, office cabinets or equipment; storage area; shelving for garden tools; tele-health or tele-medicine area or room; mini-hospital equipment; elevator; grab bar; railing; door hardware; or smoke or alarm detector.

FIG. 6 also demonstrates that recommendation 21 to modify residential property 12 may include an identification of product 39 to be used by occupant 17. Product 39 may be a communication device; utensil; wheel chair; power chair; transfer board; hoyer lift; trapeze bar; walker; cane; vertical support pole; grab bar; oxygen tank or machine; care monitoring system; home entertainment system; emergency preparedness container, or other durable medical equipment product.

As shown in FIG. 6, recommendation 21 generated by computer program 20 to modify residential property 12 may include visual presentation 40. Visual presentation 40 may be digital photograph 41 or digital video 42. Digital photograph 41 and/or digital video 42 may portray residential property 12 and/or occupant 17. More than one visual presentation 40 (e.g., digital photograph 41 and/or digital video 42) may be part of recommendation 21. Visual presentation 40 may include floor plan 104.

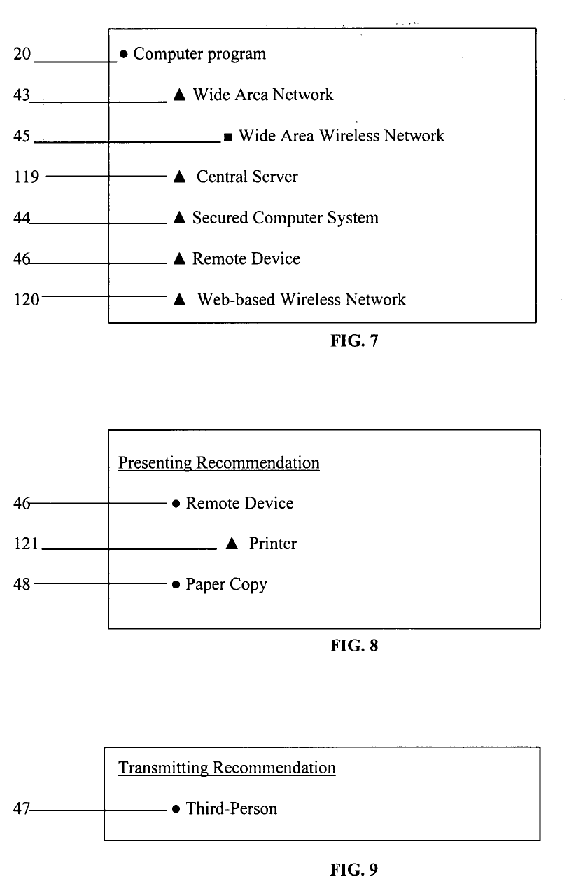

With reference to FIG. 7, computer program 20 may be part of wide-area network 43 that is accessible by Internet connection. Wide-area network 43 may be wide-area wireless network 45. Computer program 20 may be stored on central server 119 that is accessible by remote device 46 preferably via web-based wireless network 120. Remote device 46 may be used to input collected data 11, 16 into computer program 20. More than one remote device 46 may be used as part of method 10. Remote device 46 may be a laptop computer, a tablet computer, or a hand-held computer. Preferably, remote device 46 is operable by a stylus that is used to input collected data 11, 16 into computer program 20 or otherwise used to operate remote device 46. Computer program 20 is preferably is part of secured computer system 44 with all data transferred via the Internet being encrypted.

FIG. 8 illustrates that recommendation 21 generated by computer program 20 may be presented to occupant 17 by displaying recommendation 21 on remote device 46. FIG. 9 shows that recommendation 21 may be transmitted to third person 47. Third person 47 may be a contractor, subcontractor, healthcare professional, immediate family member or designated contact person for occupant 17, insurance carrier, or government agency.

As demonstrated in FIG. 8, recommendation 21 may be presented to occupant 17 by printing a paper copy 48 of recommendation 21 and displaying paper copy 48 to occupant 17. Preferably, remote device 46 is connected to printer 121 which prints paper copy 48 of recommendation 21.

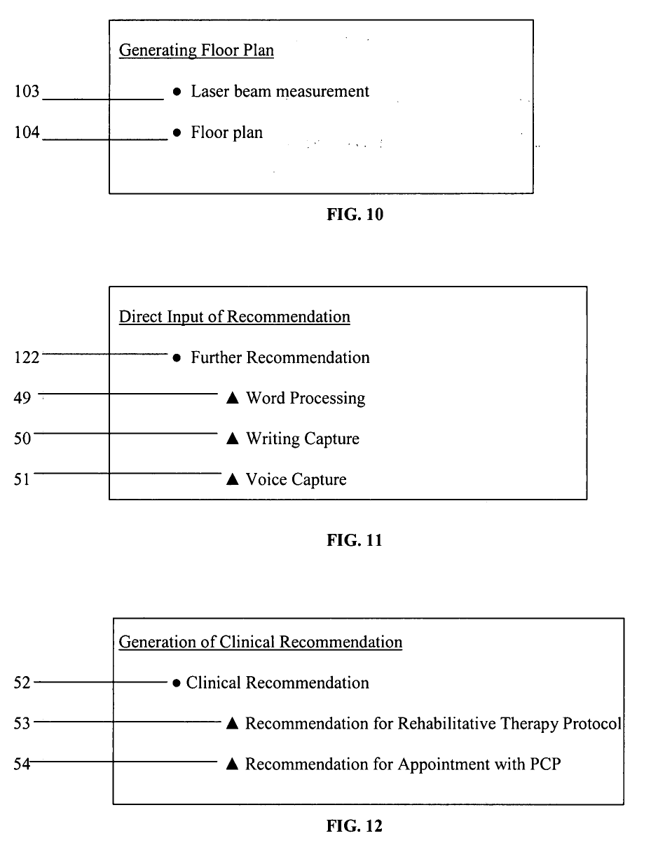

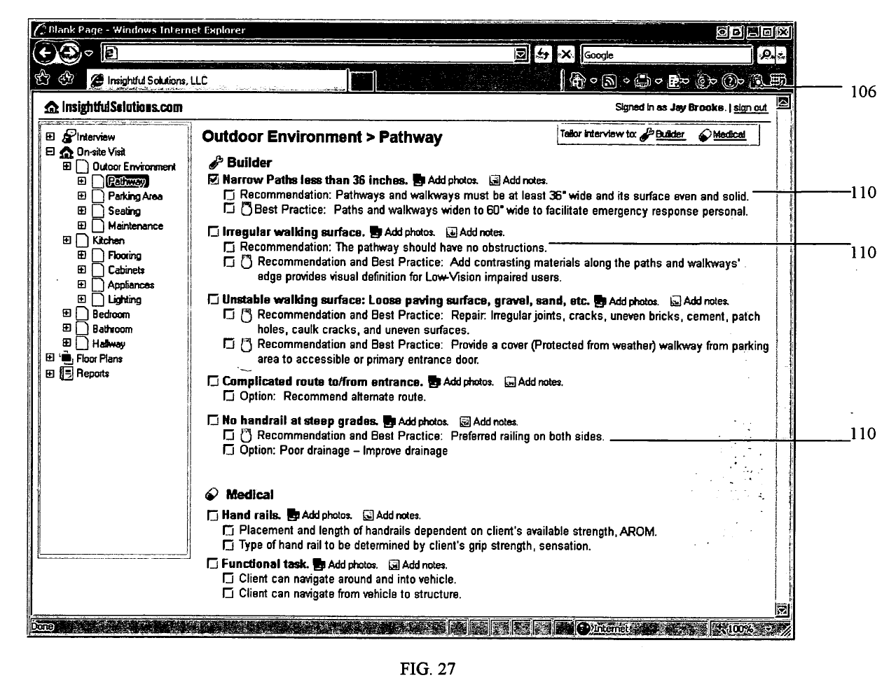

FIG. 10 shows that method 10 may include obtaining laser beam measurement 103 of residential property 12 and inputted measurement 103 into computer program 20. Computer program 20 generates floor plan 104 for residential property 12 in response to inputted measurement 103 as shown in FIG. 27. Preferably, measurement 103 and floor plan 104 are included in recommendation 21 to modify residential property 12. Laser beam measurement devices are available commercially, as for example, the Disto A6® and Disto Plus® available from Leico Geosystems.

With reference to FIG. 11, method 10 may include the step of inputting a further recommendation 122 directly into computer program 20. Further recommendation 122 may be directly inputted into computer program 20 by word-processing 49, writing capture 50, or voice capture 51. Writing capture 50 may be accomplished by using a tablet computer or a computer connected to a tablet writing device. Voice capture 51 may be accomplished by digital recording using an external digital recording device and downloading the recording to remote device 46 or a digital recording device built into remote device 46.

FIG. 12 reveals that method 10 may include the step of causing computer program 20 to generate clinical recommendation 52 for therapeutic intervention of occupant 17. Clinical recommendation 52 may be a recommendation 53 for rehabilitative therapy protocol, recommendation 54 to schedule an appointment with a primary care physician, or both.

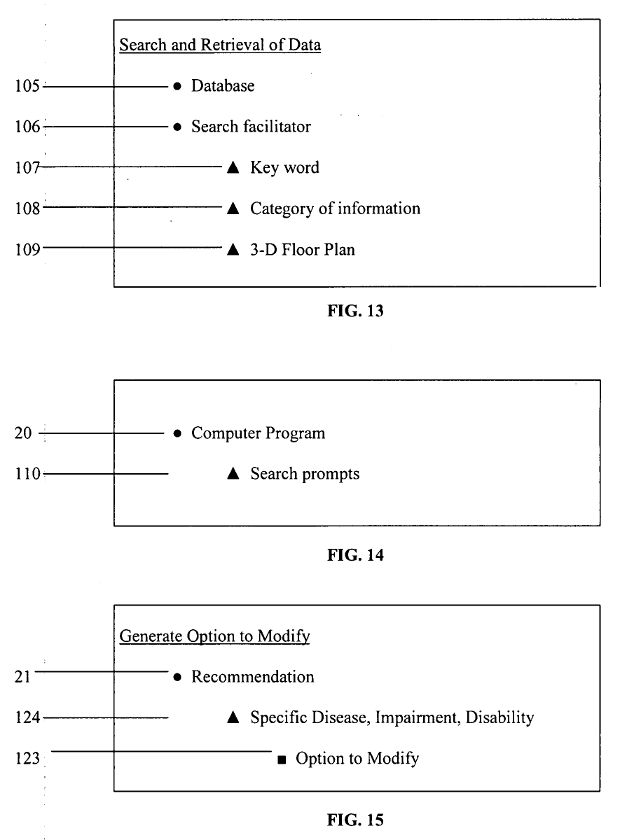

FIG. 13 illustrates that computer program 20 contains database 105. Database 105 includes collected data 11, 16 inputted into computer program 20 and recommendation 21 generated by computer program 20. Database 105 may be searched and specific information such a collected data 11, 16 and/or recommendation 21 may be retrieved. To assist in the search and retrieval of collected data 11, 16 and/or recommendation 21, computer program 20 may contain search facilitator 106. Search facilitator 106 may be key word 107, category of information 108, 3-D floor plan 109, or any combination thereof. More than one search facilitator 106 may be part of computer program 20.

With reference to FIGS. 14 and 27, computer program 20 may contain screen prompts 110. Screen prompts 110 may be used to collect data 11, 16. Screen prompts 110 may identify specific information to be evaluated, collected, and inputted into computer program 20 so as to generate recommendation 21 to modify residential property 21.

FIG. 15 details that as part of method 10, computer program 20 may generate recommendation 21 that includes option 123 to modify residential property 12 in response to designating specific disease, impairment, or disability 124 of occupant 17 within computer program 20. Specific disease, impairment, or disability may include Arthritis, Alzheimer's, Amputation, Dementia, Diabetes, Heart Disease, Joint Replacement, Low Vision or Blindness, Paralysis, Parkinson's, Stroke, Risk of Falls, Range of Motion, Multiple Sclerosis, and Down's Syndrome.

Table 2 appended hereto provides an example of the application of computer program 20 to recommend a modification to residential property 12 in response to the input of a specific disease, impairment, or disability of occupant 17.

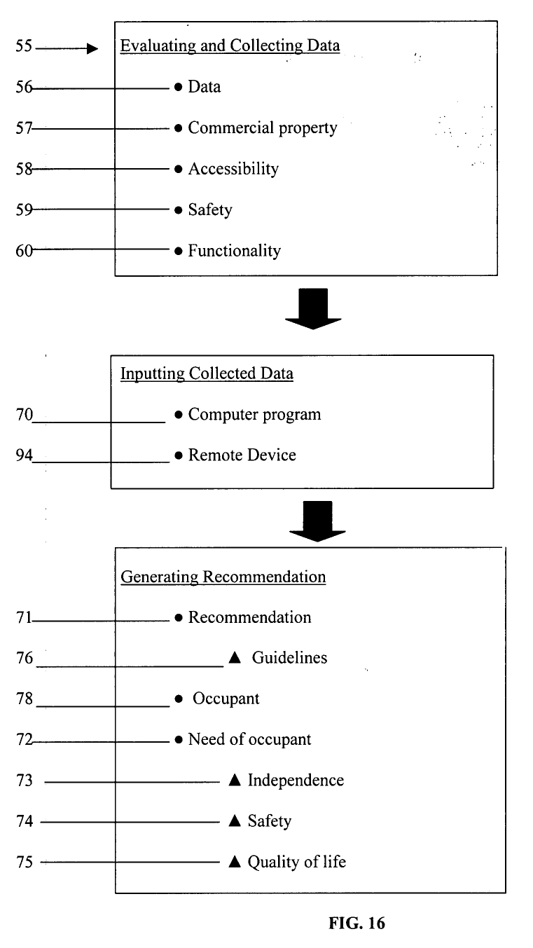

FIG. 16 is illustrative of an alternative embodiment of the present invention. Method 55 involves evaluating and collecting data 56 about accessibility 58, safety 59, and functionality 60 of commercial property 57. Collected data 56 is inputted into computer program 70. Computer program 70 generates recommendation 71 to modify commercial property 57 in response to inputted collected data 56. Recommendation 71 is intended to satisfy need 72 of occupant 78. Need 72 may be independence 73, safety 74, quality of life 75, or any combination thereof. Occupant 78 may be an invitee to commercial property 57, an employee working at commercial property 57, or an owner of commercial property 57 or a legal representative of the owner. Commercial property 57 may be an office building; public or private school, university, or college; medical professional building; restaurant; hotel; motel; commercial facility; resort; or VA, public, or private hospital.

The evaluation and collection of data 56 about accessibility 58, safety 59, and functionality 60 of commercial property 57 may be undertaken by a certified aging-in-place specialist, a licensed medical professional, or both. The certified aging-in-place specialist may be a professional remodelor, a licensed contractor, a licensed interior designer, and a licensed professional involved with housing for disabilities, products, accessibility, and aging. The licensed medical professional may be an occupational therapist, an occupational therapist assistant, a physical therapist, a physical therapist assistant, a registered nurse, or a licensed practical nurse.

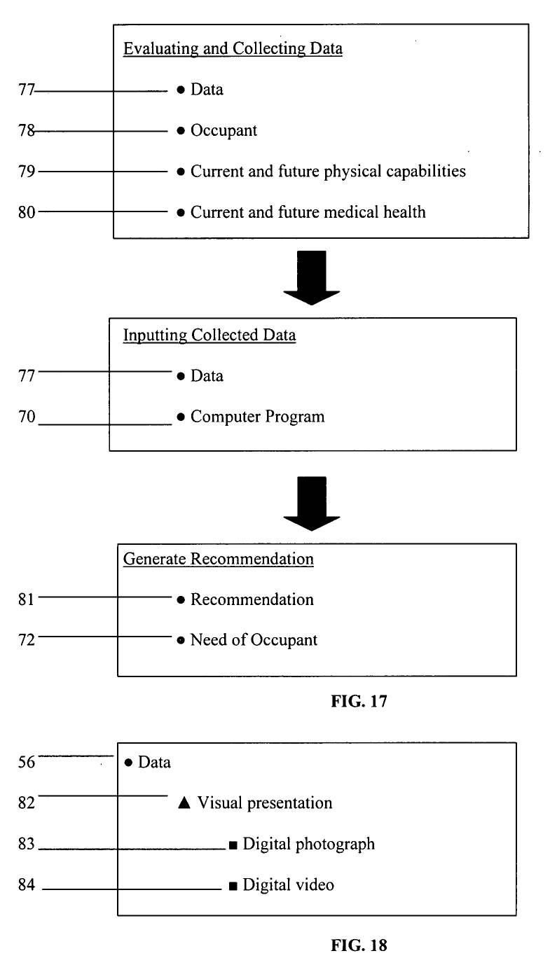

With reference to FIG. 17, method 55 may include evaluating and collecting data 77 about current and projected future physical capabilities 79 and medical health 80 of occupant 78 commercial property 57. Collected data 56, 77 may be inputted into computer program 70 and computer program 70 activated to generate recommendation 81 to modify commercial property 57 in response to inputted collected data 56, 77. The recommendation is intended to satisfy need 72 of occupant 78.

The evaluation and collection of data 77 may be undertaken by a licensed medical professional. The licensed medical professional may be an occupational therapist, an occupational therapist assistant, a physical therapist, a physical therapist assistant, a registered nurse, or a licensed practical nurse.

Collected data 77 about current and projected future physical capabilities 79 and medical health 80 of occupant 78 may include information about age; medical history; functional tasks; functional mobility; medication use including use of diuretics, narcotics, and pain relievers; hand dexterity; fall prevention; range of motion; sensory skills; endurance; mental health; progression of disease; vision; hearing; cognitive ability; olfactory capabilities; balance; strength; functional communication; or any combination thereof.

Collected data 56 about accessibility 58, safety 59, and functionality 60 of commercial property 57 may include information about needs for alterations, additions, program accessibility, essential and non-essential job functions, cosmetic work, maintenance repairs, transitions, specialized equipment, products or information, renovation, remodel modifications, targeting existing problem areas or architectural inefficiencies, plan review to eliminate costly structural changes or endorse specialized modifications for safety, prolonging the independence in the work place, quality of work styles, rearranging existing work spaces, or any combination thereof.

Collected data 56 may also include information about continuous path of travel, surface material, slope and cross-slope, curb ramp design and locations, on-street parking, alternate circulation path, islands and medians, pedestrian button location and design, accessibility of pedestrian signals, street or patio furniture style, access and placement; drinking fountains, illumination of pathways, handrails, parking spaces; warning for hearing impaired including clear signage, symbols and pictograms, clear sightlines, audible information systems louder than ambient surrounding noise; existing barriers and list physical barriers that limit accessibility, programs, activities, or services; warning for low vision including hazards of protruding objects, symbols and pictograms, blended curbs, detectable warnings, audible information systems, tactical information systems, visual contrast at steps, visual cues, wall mounts and post mounted objects; adequate shelter from weather in passenger unloading zone; entrance ramps and hand rails; width of doorways, door openers, electronic pad for security card entry, special access lifts; unobstructed routes through facility; accessible restrooms including slippery walking or hygiene issues insufficient maneuvering area, controls, toilet height, stall width, grab bar combinations, inadequate storage shelf in stall and or inaccessible places, door landings, latch side clearance, signage to identify permanent rooms and space, lighting, faucets, bank of telephones, or any combination thereof.

With reference to FIG. 16, recommendation 71 to modify commercial property 57 may include a recommendation for accessibility by developing guidelines 76 for new or altered facilities covered under the Americans with Disabilities Act (ADA) and/or the Architectural Barrier Act (ABA).

Recommendation 71 is intended to satisfy need 72 of occupant 78, which may include the enhancement of occupant 78's accessibility, the elimination of obstacles for community involvement, the improvement of work place ergonomics for increasing quality of work styles, the promotion of environmental harmony in designing for accessible communities, or any combination thereof.

FIG. 18 shows that collected data 56 about accessibility 58, safety 59, and functionality 60 of commercial property 57 may include visual presentation 82. Visual presentation 82 may be digital photograph 83 or digital video 84. Digital photograph 83 and/or digital video 84 may portray commercial property 57 and/or occupant 78. More than one visual presentations 82 (e.g., digital photograph 83 and/or digital video 84) may be part of collected data 56. Visual presentation 82 may include floor plan 112.

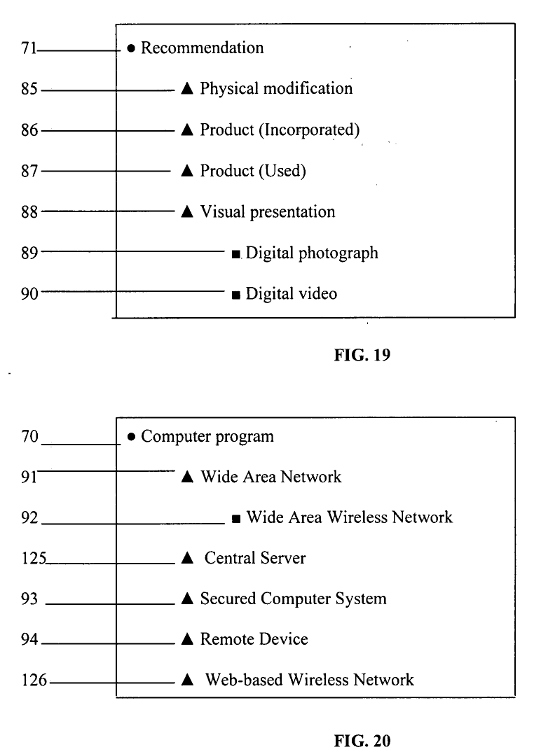

As demonstrated in FIG. 19, recommendation 71 to modify commercial property 57 may include a recommendation for physical modification 85 of commercial property 57. Recommendation 71 may also include identifying product 86 to be incorporated into commercial property 57 as part of physical modification 85. Recommendation 71 may also include the identification of product 87 to be used by occupant 78.

Again with reference to FIG. 19, recommendation 71 generated by computer program 70 in response to inputted collected data 56 may include visual presentation 88. Visual presentation 88 may be digital photograph 89 or digital video 90. Digital photograph 89 and/or digital video 90 may portray commercial property 57 and/or occupant 78. More than one visual presentation 88 (e.g., digital photograph 89 and/or digital video 90) may be part of recommendation 71. Visual presentation 88 may include floor plan 112.

FIG. 20 demonstrates that in method 55, computer program 70 may be part of wide-area network 91 that is accessible by Internet connection. Wide-area network 91 may be wide-area wireless network 92. Computer program 70 may be stored on central server 125 which is accessible by remote device 94 preferably via web-based wireless network 126. Remote device 94 may be used to input collected data 56 into computer program 70. More than one remote device 94 may be used as part of method 55. Remote device 94 may be a laptop computer, a tablet computer, or a hand-held computer. Preferably, remote device 94 is operable by a stylus that is used to input collected data 56 into computer program 70 or otherwise operate remote device 94. Computer program 70 is preferably part of secured computer system 93 with all data transferred via the Internet being encrypted.

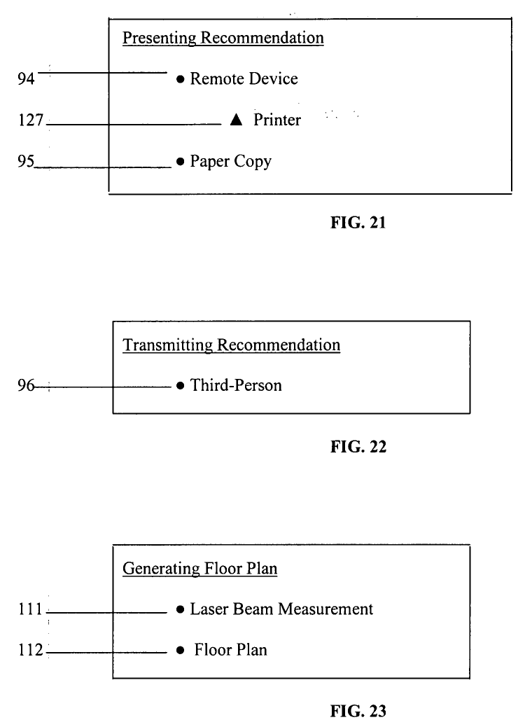

With reference to FIG. 21, method 55 may include the step of presenting recommendation 71 to modify commercial property 57 to occupant 78 by displaying recommendation 71 on remote device 94.

FIG. 22 reveals that method 55 may include the step of transmitting recommendation 71 to modify commercial property 57 to third-person 96. Third-person 96 may be a contractor, subcontractor, healthcare professional, designated contact person for the occupant, insurance carrier, or government agency.

Again with reference to FIG. 21, method 55 may include presenting recommendation 71 to modify commercial property 57 to occupant 78 by printing paper copy 95 of recommendation 71 and displaying paper copy 95 to occupant 78. Preferably, remote device 94 is connected to printer 127 (via hardwire or wireless connection) which prints paper copy 95 of recommendation 71.

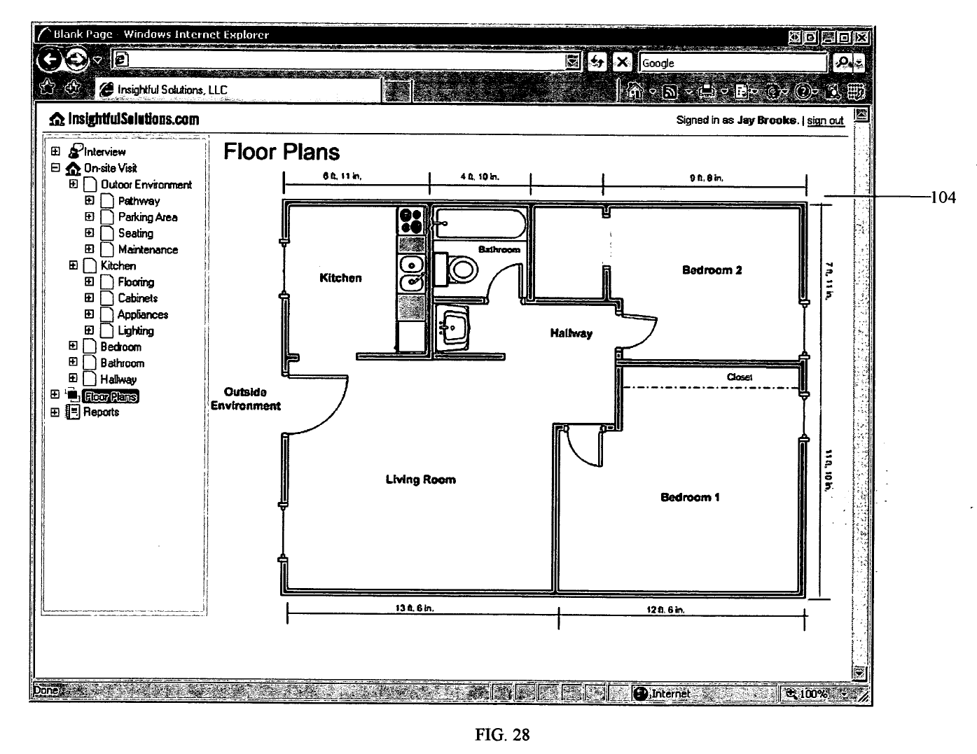

FIG. 23 details an alternative to method 55 in which laser beam measurement 111 is obtained of commercial property 57 and inputted into computer program 70. Computer program 70 generates floor plan 112 for commercial property 57 in response to inputted measurements 111 as shown in FIG. 28. Preferably, measurements 111 and floor plan 112 are included in recommendation 71 to modify commercial property 57. Laser beam measurement devices are commercially available, as for example, the Disto A6® and Disto Plus® available from Leico Geosystems.

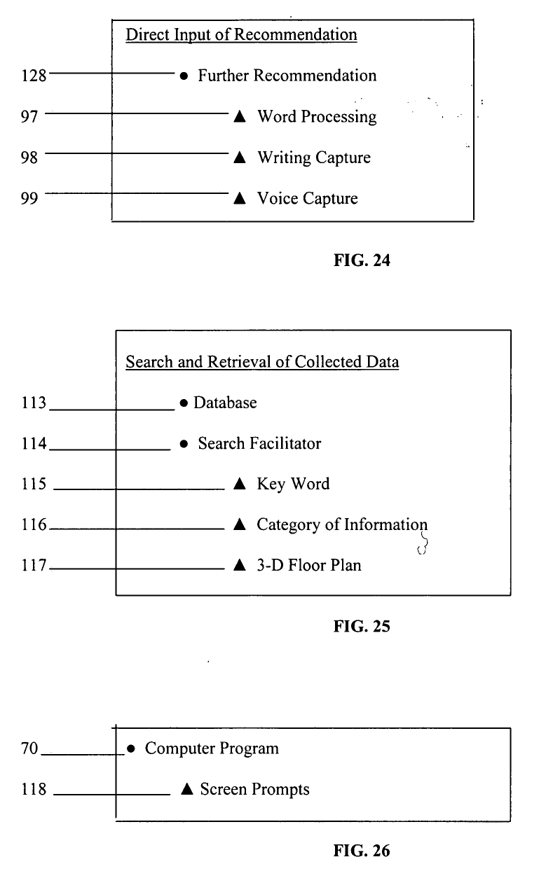

Referring to FIG. 24, method 55 may include the step of inputting further recommendation 128 to modify commercial property 57 directly into computer program 70. Further recommendation 128 may be inputted into computer program 70 via word processing 97, writing capture 98, or voice capture 99. Writing capture 98 may be accomplished by using a tablet computer or a computer connected to a tablet writing device. Voice capture 99 may be accomplished by digital recording using an external digital recording device and downloading the recording to remote device 94 or a digital recording device built into remote device 94.

As illustrated in FIG. 25, computer program 70 contains database 113. Database 113 includes collected data 56 and/or 77 inputted into computer program 70 and recommendation 71 generated by computer program 70. Database 113 may be searched and specific information such as collected data 56 and/or 77 and/or recommendation 71 retrieved. To assist in the search and retrieval of collected data 56 and/or 77 and recommendation 71, computer program 70 may contain search facilitator 114. Search facilitator 114 may be key word 115, category of information 116, 3-D floor plan 117, or any combination thereof.

FIGS. 26 and 27 shows that computer program 70 may contain screen prompts 118. Screen prompts 118 may be used to collect data 56 and/or 77. Screen prompts 118 may identify specific information to be evaluated, collected, and inputted into computer program 70 so as to generate recommendation 71 to modify commercial property 57.

The present invention blends clinical assessment of a person's functional abilities and physical qualities of the person's environment to permit the consumer to best determine his or her present but also future needs. The needs considered are not only that of the person with a disease or disability but also the needs of the care giver. A care giver may be a hired assistant or a family member, e.g., a parent of a developmentally handicapped child or the spouse of an aging or disabled husband or wife or the child of an aging parent. The opportunity of a consumer to have a professional team assess not only the needs of the person with the disease or disability but the needs of care givers brings peace of mind and helps reduce the turn-over rate of care givers resulting in better care for the loved one.

The method of the present invention permits the clinician to evaluate all areas of a residential or commercial property in a systematic manner to provide a thorough assessment. The method focuses primarily on functional tasks that the resident or user of environment must perform in a reasonable, timely, and safe manner. Each person's physical, metal (cognitive) capacity will be considered when an assessment is conducted. Examples of theoretical assessments are described below.

### EXAMPLE 1

An assessment is requested at the home of a couple who have a three-year old child with cerebral palsy. The wife is expecting a second child. The only care givers for the child are the parents. The parents anticipate that the mother will need assistance with the three-year old who is wheelchair bound and unable to perform any self-care skills (e.g., bathing, toilet functions, dressing, etc.) without assistance. Bathing the three-year old in a tub, even without the mother's pregnancy, is challenging and becoming unsafe for both the child and the care giver. Using method 10 and computer program 20, the clinician will not only assess the functional abilities of the disabled child but the needs of the care givers as they age. The child's physical and cognitive abilities will be evaluated and his safety as the child moves around the home and becomes more mobile in his wheelchair. Factors considered are: Will the child be able to independently propel himself through the home? Will the child be safe in the kitchen when meal preparation is undertaken? What safety mechanisms can be put in place? Computer program 20 may recommend using induction cook tops to prevent burns, placing sharp utensils out of reach, using stove top controls that lock or are not situated on the stove front. To address teaching the child functional tasks such as home maintenance, computer program 20 may recommend placing appliances within easy reach, replacing cabinetry with rolling carts containing dishes that are better accessible from a wheelchair. As the parents age, they also would benefit from an ergonomically designed kitchen. Computer program 20 may recommend duel countertop heights that would meet the needs of all family members. In the bathroom, computer 20 may recommend a roll shower with bench area that would also benefit the child and parents as they age. Thus, computer 20 recommends a phased design taking into consideration the short term and long term needs of the disabled child and his care givers. The child will be able to live in the home longer because the parents will have the capability to properly care for him in their home. The parents' needs are also met by the creation of not only a functional environment, but a home environment that is aesthetically pleasing and designed so that the family can grow old therein.

### EXAMPLE 2

If a builder is called in for an assessment of a person with Multiple Sclerosis (MS), the builder could easily overlook a deficit that would not ordinarily be considered. For example, a person with MS has obvious physical limitations that will progressively worsen. Often overlooked are flare-ups of optic neuritis that causes vision difficulties. The vision problems will result in self-care difficulties, as for example, medication administration (oral and injectable medications), reading, and cooking (diminished ability to see dials). The vision disturbances may subside for a time once inflammation of the optic nerve reduces, but the flare-ups nonetheless must be addressed for safety reasons. Computer program 20 is pre-programmed with recommendations for those suffering from MS. By inputting that the person being assessed has MS, the builder would be given a list of modifications for the home specific to persons with MS, with such modifications being a phased design addressing the progression of the disease over time. Computer 20 functions to prompt the clinician to access functional areas. This forces the clinician to evaluate the person in a holistic manner to determine barriers interfering with the completion of required functional tasks. Computer program 20 would also have available links to web sites providing information of various disease processes to allow the most up-to-date disease information at the fingertips of the evaluator.

TABLE 1
ENVIRONMENTAL AND MEDICAL ASSESSMENT
Outdoor

Walking Surface

| | |
|---|---|
| □ | Narrow paths less than 36″ |
| □ | Recommendation: Paths and walkways must be at least 36″ wide and |
| | its surface even and solid. |
| □ | Best Practice: Paths and walkways widen to 60″ wide to facilitate |
| | emergency response personal. |
| □ | Irregular walking surface: |
| □ | Recommendation: The pathway should have no obstructions. |
| □ | Recommendation and Best Practice: Add contrasting materials along |
| | the paths and walkways' edge provides visual definition for |
| | Low-Vision impaired users. |
| □ | Unstable walking surface: Loose paving surface, gravel, sand, etc. |
| □ | Recommendation and Best Practice: Repair: Irregular joints, cracks, |
| | uneven bricks, cement, patch holes, caulk cracks, and uneven |
| | surfaces. |
| □ | Recommendation and Best Practice: Provide a cover (Protected from |
| | weather) walkway from parking area to accessible or primary |
| | entrance door. |
| □ | Complicated route to/from entrance |
| □ | Option: Recommend alternate route |
| □ | Steep grades (more than 1:12) alternate route w/ramp |
| □ | No handrail at steep grades |
| □ | Recommendation and Best Practice: Preferred railing on both sides. |
| □ | Poor drainage - Option: Improve drainage |

Parking

| | |
|---|---|
| □ | Parking should be located as close as possible to the most accessible |
| | or primary entrance door. Accommodations for wheelchairs, |
| | mobility aids, and functional mobility, cognitive or sensory skills are |
| | all involved in the parking and critical path to the residence. |
| □ | Adequate clear space around parking area. |
| □ | Narrow parking spaces. |
| □ | Parking space is more than 30′ walking distance from the entrance. |
| □ | Option: Recommend alternate route. |
| □ | Inadequate shelter from weather in passenger loading zone. |
| □ | Option: Provide a sheltered resting/seating area. |
| □ | Option: Increase width of parking area. Widen parking access for |
| | (un)loading zone perimeter to a minimum 96″ inches wide with |
| | adjacent access isle of 60″ inches wide. |
| □ | Note: Parking spaces should have a minimum width of 13′6″. |
| | A single-car garage should have a minimum width of 14′6″. |
| □ | Uneven surface at loading zone and parking area |
| □ | Recommendation: Patch holes, caulk cracks, and uneven surfaces |
| | in the parking area. |
| □ | Option: Improve the surface/type/condition of parking area. |
| □ | Garage is attached/ detached. |
| □ | Note: For a Detached Carport or Garage. Provide a covered |
| | passageway with adequate overhangs for protection against |
| | inclement weather. |
| □ | Note: In a garage or carport a passageway 4′0″ wide should be |
| | provided in front of or behind the automobile. A garage or carport |
| | should therefore have a minimum length of 24′0″. |
| □ | Recommendation: Provide a suspended stirrup grip or hoist lift |
| | to facilitate transfer to and from the automobile. |
| □ | Option: Elevate Garage to floor lever, so vehicles do the climbing. |
| □ | Automatic garage door opener |
| □ | Adequate lighting in parking area (performed in Daylight or |
| | Darkness) |
| □ | Option: Parking area light switches and garage door openers are at a |
| | recommended height of 36″ to 48″ above finish parking |
| | surface to allow for convenient accessibility. |
| □ | Option: Replace fixture w/ long-life bulbs |
| □ | Clutter/Obstacles (i.e., bicycles, trash cans) |
| □ | Recommendation: Remove obstructions from around parking area |
| □ | Curb cuts needed |
| □ | Recommendation: Cut at curbs, sidewalk, or driveways for smooth |
| | wheelchair or mobility aids access. |
| □ | Option: Add railings |
| □ | Option: Improve grading |
| □ | Pathway: The pathway will be smooth, solid, firm, continuous, level |
| | and of a non-slip material. |

Pathway

| | |
|---|---|
| □ | Lights are on photocell or sensor system |
| □ | Recommendation: Install auto controls for lighting |
| □ | Poor lighting along path; Poor lighting along walking surface |
| □ | Option: Platform lift |
| □ | Option: low-rise steps (see OT eval) |
| □ | Option: alternate walkway |
| □ | Option: alternate surface |
| □ | Option: alternate grading |

Lawn and Landscape

| | |
|---|---|
| □ | Recommendation: Improve sufficient maneuvering space at the |
| | mailbox and the outside storage room. If the mailbox or storage |
| | room is difficult to reach - i.e., can only be reached via steps |
| | or other differences in levels consider an alternate location. |
| □ | Option: Remove overhanging objects along the pathway. Clean |
| | and seal hard surfaces to prevent falls. |
| □ | Recommendation: Raise landscape beds for flowering or vegetable |
| | garden access. Raising the beds can help reduce fatigue and stress on |
| | your back if bending over is difficult |
| □ | Note: Suggest adaptations for new or renovations for landscaping, |
| | low-maintenance shrubs & plants, |
| □ | Option: Install a landscape irrigation system for landscape shrubs, |
| | plants and grasses. |

Deck/Balcony Assessment and Recommendations

| | |
|---|---|
| □ | Easy to open or lock patio doors or screens |

Interior

Accessible or Primary Entrance Door

| | |
|---|---|
| □ | The most accessible entry door to the home is the connection to |
| | the rest of the world. It is important for receiving guests, for |
| | bringing in the deliveries, for going to and from appointments. |
| □ | Recommendation: Install a Barrier-free (stepless) entryway. |
| | The walkway leads from the driveway and sidewalk to the entrance |
| | with no steps and very little slope, if any. (Best practice is the |
| | main living on a single story, including a full bath. |
| □ | Option: A flush threshold is preferred. Eliminate door thresholds |
| | over ¼″ that could impede access. (Maximum rise @ threshold |
| | is ½″ beveled) |
| | Note: Any vertical obstruction with the height greater than ½″ |
| | will trip the small front wheels of the wheelchair. Note: Non-slip |
| | flooring @ entry. |
| □ | Recommendation and Best Practice: Provide a 36″ frame or a 32″ |
| | clearance when the door is open for minimum 180 degrees. |
| □ | Option: Install a 10″ to 12″ high kick-plate mounted at the |
| | bottom of the door. |
| □ | Option: Add a view of visitors (including children and seated users) |
| | through sidelights, peep-hole at standard height & lower heights of |
| | (45″ to 48″ from lower edge of door), add wide angle viewers, TV |
| | monitors, and side windows at or near by the door to view visitors. |
| □ | Recommendation: Provide a place for packages while opening doors, |
| | built-in shelf, bench, or table with knee space below located on the |
| | latch side, at an accessible height, next to the door. |
| □ | Note: Provide an 18″ in width minimum clear floor space beside |
| | door on pull side at the latch jamb. |
| □ | Recommendation: Provide inclement weather protection shelter while |
| | (un)locking & opening doors. Options: Protection may include |
| | porches, awnings, carports, stoops with roofs or extended |
| | roof overhangs. |
| □ | Method to Communication with visitors: |
| □ | Option: Provide a Lighted door bell 36″ to 48″ above porch/floor; |
| | hardwire intercom, and or portable telephone link. |
| □ | Insufficient maneuvering space at entry door. |
| □ | Recommendation and Best Practice: Provide a minimum 5′ × 5′ level |
| | clear space on both the outside and inside of entry door. Note: |
| | Level means the clear space, deck or platform may be sloped ⅛″ per |
| | foot to provide drainage. |
| □ | Locking System |
| □ | Recommendation: Provide automatic deadbolt and door opener with |
| | programmable delay time. |
| □ | Option: Install an electronic locking system with keypad, magnetic, |
| | remote control, or push button locking system to minimize the |
| | need to manipulate keys. |
| □ | Note: Keypad would be accessible to emergency personnel, |
| | caregivers. |
| □ | Safety at entrance |
| □ | Option: Install vertical grab bar(s) near latch side of the door |
| | opening if resident would benefit from grab bar(s) to help pull |
| | themselves through door and over threshold. |
| □ | Recommendation: Install or reinforce handrails on steps, between 34″ |
| | and 36″ above nose of treads |
| □ | Recommendation: Handrails are a contrasting color |
| □ | Lighting: Light entrance to home with a two bulb - long-life fixture. |
| □ | Option: Install an exterior flashing blue emergency strobe light that is |
| | activated with a 911 call. |

Hallway/Living Room/Dining Room

| | |
|---|---|
| □ | Interior Circulation: Critical path through the house: Reduce the |
| | amount of furniture to make it easier to get around and create open |
| | space, select furniture that is easy get in and out of. Arrange |
| | the furniture and space to allow for the maximum access along a |
| | route that is unobstructed. |
| □ | Option: Remove all protruding objects from the critical path through |
| | the house that is less than 27″ from the floor. |
| □ | Option: Widen door ways with offset hinges |
| □ | Option: Widen hallways & archways to a minimum width of 42″ to |
| | provide maneuvering room to accommodate walkers, |
| | wheelchairs or visitability. |
| □ | Option: Install handrails the in hall for balance and falls prevention or |
| | where client is ambulatory (walking). |
| □ | Recommendation: Provide a 5′ diameter turning space in all rooms. |
| □ | Carpeting - See Flooring |

Interior Stairs

| | |
|---|---|
| □ | Recommendations and Best Practices for Stairs: Considerations for a: |
| | Split level, two story, stairs to second level of residence, |
| | main floor to basement, stairs to attic. |
| □ | Option: In modification for the client's mobility impairments - in new |
| | construction the width of stairways should allow for future |
| | installation of chair lifts. |
| □ | Note: Chair lifts (Inclined Elevators) (stair glide) offer an alternative |
| | to the climbing of stairs. Such lifts are easily installed and |
| | require minimum modification to existing stairs. Chair lifts are |
| | generally not suitable for wheelchair users. Note: OT to coordinate |
| | proper lift for client with the considerations for support, arm rest, |
| | 360 degree seat, an accessible send and call box, the width of the |
| | chair in folder position (varies), seat belt, and adequate knee space. |
| | Contractor should provide a back up power system in the event of |
| | a power failure. |
| □ | Note: Handrails in the stairwell must be compatible with the function |
| | of the chair lift. |
| □ | Note: Provide an electrical 110 duplex outlet at the bottom of the last |
| | tread. (consult with DME for specs) |
| □ | Option: A wheelchair lift/platform suitable for installation on most |
| | existing stairs are commercially available. When not in operation, |
| | the lift stores at the bottom of the stairs to permit normal |
| | use of the stairway. |
| □ | Option: Review handrails placed too high/low or existing handrails |
| | too short. |
| □ | Options: Install handrails on both sides of stairs(extending |
| | 12″ to 18″ past top & bottom of stairs. |
| □ | Recommendation: Install non-skid strips or use non-skid paint on stair |
| | treads. Consult with OT to install rug runners to create a |
| | non-slip surface for the stairs |
| □ | Recommendation: Install or reinforce handrails on steps, between 34″ |
| | and 36″ above nose of treads |
| □ | Recommendation and Best Practice: Handrails are a contrasting color |
| | from the walls and covering on the stairs. Stairs have uneven risers |
| | heights and/or stair trends are narrow or irregular depth. |
| □ | Option: Renovate existing stairs using consistent tread depth and riser |
| | height |
| □ | Stairwell Lighting: Poor illumination of stairwell or handrails: |
| □ | Option: Provide non-glare accessible Lighting. Light switch(es) |
| | height at top and bottom of stairs is 36″ to 48″ above |
| | nose of tread. |
| □ | Option: Install three-way switch, accessible from top and bottom |
| | of stairs. |
| □ | Option: Improve illumination with 2 bulbs/long lasting light fixtures |
| | at top/bottom of stairwell. |

Types of Ramps: Portable and Stationary

| | |
|---|---|
| □ | Curb: Use where there are no curb cuts, or for short stairs (1 to 2 |
| | steps) |
| □ | Recommendation: May be portable, roll-up or folding and usually |
| | 3 feet in length. If left in place permanently, it should be bolted |
| | at the top and bottom for safety. |
| □ | Folding: Use where longer than curb ramps, 3 ft & up. Most have |
| | handles on the sides: Pathway ramp w/ handrails; Suitcase ramp |
| | 3′ to 6′; Tri-fold ramps; EZ Access Roll-up ramps; |
| | Stationary ramps: Generally wider, longer and heavier than |
| | portable ramps. They require support along the length. |
| □ | Best Practice: A safety lip must be installed on the running edge |
| | or side edge of the ramp to ensure that a wheel from a chair |
| | or device will not go over the edge. |
| □ | Best Practice: 5′ × 5′ resting platform every 30′ and every |
| | switch-backs. |
| □ | Modular ramp systems: Generally made of anodized aluminum, with |
| | handrails, adjustable support legs may come in custom colors/offered |
| | in many configuration options from straight ramps to complex |
| | custom configurations. |
| □ | Quick Ramp Kit Systems: Ideal for the do-it-yourself, ordinary |
| | lumber with adjustable support ramp system at a lower cost. |
| □ | Threshold ramps: |
| □ | Note: EZ-Edge threshold ramps - 100% recycled rubber; EZ threshold |
| | ramps - 1″ to 6″ inches |
| □ | Option: Consider the maximum load |
| □ | Note: According to the ADA the recommendation grade for a ramp |
| | is of a 1 to 12 ratio (one inch of rise for every twelve |
| | inches of ramp length) the preferred slope has a 1:20 ratio. |
| | This gentler slope can accommodate the weather of Montana and |
| | allows for use with rain, ice and snow. |
| □ | Note: Add comments for the 1:20 ration from an OT's perspective |
| | (i.e., patient endurance, diabetes, heart disease, arthritis, |
| | respiratory problems, neurological disorders, and overeducation) etc. |
| □ | Notes: Ramp surface involves risk of falling. |
| □ | No Handrails - Recommendation: Handrails are required on both |
| | sides and banisters that are securely attached, without |
| | interruption and extend 12″ to 18″ past the end of the |
| | ramp or stairs for balance, stability and warning in the change of |
| | levels approaching. |
| □ | Recommendation and Best Practice: Handrails should be painted, |
| | stained, or coated with a contrasting color to the adjacent walls. |

Lifts and Acknowledged Conditions

| | |
|---|---|
| | The two types of interior lifts are platforms and chair lifts. |
| □ | Exterior Lifts: |
| □ | Lift does not stop at same level as building floor |
| □ | Wide gap between the lift and the building floor |
| □ | Doors that do not stay in open position/closes quickly |
| □ | Locking device is required on the door |
| □ | Lift stops abruptly |
| □ | No handrail in lift |
| □ | Heavy doors without automatic opening |
| □ | No seat in lift |
| □ | Cramped lift - less than sq ft. |
| □ | Controls and operating hardware are in-accessible |
| □ | Design of controls requires good hand function |
| □ | No audio signal when the lift arrives |
| □ | No visual signal when the lift arrives |
| □ | Lift signals do not indicate the direction of the lift |
| □ | Note: A steep transition from one level to another, is when the slope |
| | is greater than 1:12. |

General Items Assessment and Recommendations

| | |
|---|---|
| □ | Recommendation: Door bells and mailboxes should be mounted |
| | at a convenient height of 36″ 45″ inches. |
| □ | Recommendation and Best Practice: Clients may be especially |
| | vulnerable to cold and drafts. In some instances, it may be desirable |
| | to provide zone - controlled heating to allow the client the |
| | independent temperature control for the master bedroom and bath. |
| | Bathroom heat may be further supplemented by a radiant heat |
| | lamp on a timer. |
| □ | Note: Locate all switches, thermostats and other environmental |
| | controls in an accessible location placed at a maximum height of |
| | 48″. The preferred height is 36″ to 45″ inches. Note: |
| | Suggest Pre-programmed thermostats. |
| □ | Note: The client's medical condition and functional mobility will |
| | determine to proper height. |
| □ | Recommendation and Best Practice: Locate electrical outlets 15″ |
| | above the finished floor, outlets may need to be closer than 12″ apart. |
| □ | Note for Lighting: Multiples sources of lighting will include general |
| | lighting, task lighting, in-cabinet light fixtures, all provide |
| | sufficient illumination. |
| □ | Note: See Iron-a-way - notes in Appliances for an accessible height |
| | ironing board. |
| □ | Consider Mobility: Evaluated where the electric wheelchair and |
| | scooters are plugged-in. |
| □ | Recommendation: Widen doorways, if needed. ADA guideline is a |
| | minimum of 32″. Best practice is 36″ |
| □ | Hallways Widen existing hallway to 42″ inches to accommodate |
| | walkers or wheelchairs or visitability. |
| □ | Option: Add sufficient storage to reduce clutter |
| □ | Recommendation: Hardware - Install easy-to-manipulate door |
| | hardware and locks: avoid traditional thumb-activated |
| | mechanisms. |
| □ | Option: Install electronic devices that warn when appliances are |
| | left on or shuts the appliance off and ones to call for assistance |

Kitchen Assessment and Recommendations

| | |
|---|---|
| □ | Color contrast, counters, flooring, walls and doors, lighter colors to |
| | brighten the kitchen |
| □ | Light switch locations, hood fan & light, disposal switch and |
| | other duplex outlets |
| □ | Recommendation: Provide a pull-out faucet with levered handles. |
| | Cabinets |
| □ | Option: install more base cabinets than uppers |
| □ | Option: Some Upper cabinets could be no higher than 48″ from |
| | the floor or resting on the counter top. 180 degree opening |
| | hinges for barrier-free access |
| □ | 32½″ high base cabinets, w/ roll-out trays. The 32-inch |
| | countertop height accommodates a variety of seating, including a |
| | wheelchair, stool, or a child's booster seat. |
| □ | 34½″ base cabinets, w/ roll-out trays |
| □ | Cabinetry features 9-inch high, 6-inch-deep toe kicks. |
| □ | Recommendation: Pull out cutting board & table, with roll-up doors |
| □ | Note: Variable cabinet heights integrated with standard. Cabinetry |
| | will speak to the specific needs without sacrificing style. Note: |
| | Multi-level work areas will accommodate food preparation at |
| | differing heights and abilities. |
| □ | Recommendation: Increase the use of contrasting colors between |
| | adjacent surfaces and on control mechanisms to make them easier to |
| | use. |
| □ | Note: Suggest glass-front cabinet doors, open shelving for easy |
| | access to frequently used items, and base cabinets with roll-out |
| | trays and lazy susans. |
| □ | Base Chef Pantry, Utensil Drawer Kit |
| □ | Base Cabinet with Sliding Shelf |
| □ | 36″ Wide Utility Cabinet with Pantry Kit |
| □ | Easy Reach Corner Cabinet |
| □ | Corner Sink Base Cabinet with Rotary Kidney Shelves |
| □ | Base cabinet, Drawer Spice Rack |
| □ | Base cabinet, pull-out Spice Rack |
| □ | Base cabinet, Tray Divider |
| □ | Vanity base - Cosmetic Drawer Insert |
| □ | Countertops |
| □ | Option: ADA cabinets |
| □ | Option: Select durable, easy-to-clean & easy - maintenance |
| | Solid-Surface counter tops by SileStone, Corian, and/or Granite. |
| | Note: Solid-surface countertops with contrasting color borders |
| | (strips in the middle) will provide a visual orientation to the |
| | workspace. (Contrasting where the countertop ends and the floor |
| | begins.) |
| □ | Option: Set counter tops at varying heights to accommodate |
| | standing or sitting |
| □ | Option: A touch - button raises and lowers the sink height |
| | from 28″ to 36″ inches. At its lower position it's |
| | wheelchair accessible . . . raised to 36″ inches, the counter |
| | matches standard base cabinets |
| □ | Wall Cabinet storage becomes accessible. A push button adjusts |
| | Approach ™ for the cabinet 20″ inches from standard |
| | height down to a 36″ inch counter, or one that's 34″ inches. |
| | Includes a safety feature of automatic shutoff during downward |
| | travel. |
| □ | Kraftmaid, Passport Series cabinetry, universal/ADA kitchen and |
| | laundry www.kraftmaid.com |
| □ | AD-AS-Touch of a button, ANSI/ADA accessibility www.as-as.com |
| □ | California Closets - www.calclosets.com |
| □ | Marsh Furniture Company - www.marshfurniture.com |
| □ | Rev-A-Shelf - www.rev-a-shelf.com |
| □ | Other - Equal or equivalent |
| | Appliances |
| | ADA Compliant |
| □ | Recommendation and Best Practice: is an Electric Cooktop with level |
| | burners for safety in transferring between burners, front controls |
| | and downdraft venting to pull the heat away from the client. |
| | Note: Electric Cooktops must have a light to indicate when |
| | the surface is hot. |
| □ | Option: Elevate dishwasher 12″ above the floor to facilitate loading |
| | and unloading |
| □ | Option: Promote upgrading appliances that not only enhance the look |
| | and feel, but also provide easy access. |
| □ | Option: Use small appliances that are more lightweight and easier |
| | to grip |
| □ | Option: select a convenient - stair less location for the washer |
| | and dryer |
| □ | Option: Washers and dryers that are front-loading, with easy-to-reach |
| | controls, and filters. Raise washing machine and dryer 12″ to 15″ |
| | above the floor. |
| □ | Option: Offer a ADA compliant built-in Ironing board/center |
| □ | Option: Suggest Sharp's Microwave Drawer - no need to remove |
| | dishes from the oven to check or stir food. Microwave drawer |
| | can be opened and closed automatically with one finger. |
| | Front mount touch controls-designed to mount under the |
| | counter top for optimal convenience accommodating for special |
| | needs. |
| □ | Recommendation: Side by Side Built-in Refrigerator/Freezer for an |
| | accessible forward reach approach. |
| □ | Recommendation and Best Practice: Microwave oven at counter |
| | height or in the wall. |
| □ | Recommendation: Provide accented strips on countertops to |
| | provide visual orientation to the workspace. |
| □ | ASKO - www.askousa.com |
| □ | GE Appliances - www.GEAppliances.com |
| □ | Whirlpool - www.insideadvantage.com |
| | Bedrooms |
| □ | Key Considerations |
| □ | Recommendation and Best Practice: The minimum width preferred |
| | on all bedroom door is 36″. An opening of 2′8″ is acceptable |
| | only in renovation work where a 36-inch opening is impossible. |
| □ | Recommendation: All doors must allow an 18-inch clear area in |
| | width on the latch side of the door on both sides. |
| □ | Note: A pull handle on the trailing side of the door will enable the |
| | client to pull the door closed as he or she passes through. |
| □ | Recommendation: Eliminate the use of extension cords for safety |
| □ | Option: Install bed rails and overhead trapeze bars to facilitate |
| | transferring and repositioning. Situate a commode next to the bed for |
| | immobile or incontinent clients |
| □ | Recommendation: Provide a clear area with a minimum of 36-inch |
| | on at least one side of the bed. This space will allow the client |
| | to position the wheelchair for transfer to the bed. |
| □ | Option: Walk-in closets with storage at different heights. Note: |
| | Ideally, provide a minimum turning radius of 5′ both in the walk-in |
| | closet and in front of all closets. Note: Ideally, add extra duplex |
| | plugs for the backup charging of wheelchairs or scooters. |
| □ | Option: Install Bi-fold Doors with loop handles can provide the |
| | greatest access to the closet interior - Provide a light in the closet |
| | for illumination (Rocker light switch at 48″ above finished floor) |
| □ | Option: Install accessible closet systems-adjustable rods to facilitate |
| | access and risk of falls. |
| □ | Recommendation: All shelves should be reachable and adjustable |
| | with a maximum forward reach of between 15″ & 48″ - Maximum |
| | side reach of 9″to 54″ above the floor. |
| □ | Note: Storage drawers should have looped handles. It is advisable |
| | to work with an OT to determine to best heights of counters, closet |
| | rods and placement of drawer for accessibility. |
| □ | Closets: Install full-extension drawers, sliding baskets, bins, and |
| | boxes. |
| □ | Option: Re-locate the telephone, medications, electronic controls and |
| | personal item within the clients reach to reduce the risk of falls. |
| | Rocker light or touch switches reachable from the bedside, |
| | located 36″ to 40″ above the floor. |
| □ | Electrical: Install nightlights to illuminate the pathway and |
| | obstacles in the pathway of a wheelchair or walker. |
| □ | Electrical: Option - Install Luminous, accessible, pressure sensitive or |
| | rocker light switches in bedroom, bathroom & hallway. 36″ minimum |
| | to 48″ maximum above the floor for accessibility. Option: |
| | Provide contrasting color switch plates. |
| □ | Electrical: Strobe light or vibrator-assisted smoke and burglar alarm. |
| □ | Lower window sills for an accessible means of Egress. Accessible |
| | windows that open and close with 5 lb pounds of pressure |
| | (24″ to 28″) above floor as a direct emergency exit to outside. |
| □ | Recommendation: Levered door handles instead of knobs. |
| □ | Option: Incorporate a personal emergency response system |
| | installed or wearable. |
| | Bathrooms |
| □ | The bathroom is a relatively confined space and yet extensive |
| | maneuvering is usually necessary. |
| □ | Note: Consult with OT - The client will have their own transfer |
| | technique. Additionally, the client will usually prefer a particular |
| | direction of transfer, either from the right or the left. When possible, |
| | bathtubs, toilets, and showers should be located to accommodate |
| | that preference. |
| □ | Slip-resistant floor tiles or smaller tiles with more |
| | grout lines to reduce chances of falls. Option: Use rectangular |
| | 1″ × 3″ sub-way tiles on a custom roll-in shower |
| | (zero-threshold shower) |
| □ | Recommendation: ADA approved 18-inch-high toilet is easier to use/ |
| | raising the level of toilet and doesn't require as much bending. Note: |
| | Provide at least 18-inches from each of the adjacent walls to allow |
| | freedom of movement for the client or the caregiver to assist. |
| □ | Option: Add Bidet seats |
| □ | Recommendation and Best Practice: Roll-in shower (zero-threshold |
| | shower floor) or Walk-in Safety Bath tub. |
| □ | Recommendation: To accommodate wheelchair maneuvering, |
| | provide a clear area with a minimum diameter of 5′0″. |
| □ | Option: New technology for Safety Tubs Walk-in Tubs. OT to |
| | recommend this walk-in-tub, a hot tub or whirlpool. The walk-in-tub |
| | includes a convenient 17″-inch chair-height and slip-resistant |
| | floor. Tub measurements are 51-inches long, 37-inches in height, |
| | and 30-inches wide. |
| □ | If possible. add seating in bathroom to dress and undress |
| □ | Option: For a custom shower/build in a large, wide seat/bench in the |
| | shower to provide seating and a place for toiletries. |
| □ | Option: Body sprays & Showerheads: Flush to the wall, low profile |
| | body sprays (body-jets) are a well-balanced union for subtlety and |
| | efficiency by delivering voluminous amounts of water for a |
| | stimulating or soothing hydrotherapy experience. |
| □ | Recommendation/Best Practice: A molded seat is a useless feature |
| | if it is not big enough to stabilize a person with poor sitting |
| | balance and takes up just enough space to impede an attendant's |
| | or care givers aid or the use of a shower chair. |
| □ | Option: Select Cabinetry and vanity features that offer special |
| | heights and access options. Design a dual-use vanity to include |
| | a taller 36-inch and a shorter 32-inch cabinet height. |
| □ | Recommendation and Best Practice: Design of the toilet paper holder |
| | allows rolls to be changed with one hand. |
| □ | Option: Include an attachment to raise the shower seat |
| | Install easy - maintenance vanity Solid-Surface counter tops by |
| | Silestone, Corian, and/or Granite. Note: Solid-surface countertops |
| | with contrasting color border (strips in the middle) will |
| | provide a visual orientation to the workspace. |
| □ | Option: Consider an electric bed that can be lowered for easy access. |
| | (review electrical outlets for availability) |
| □ | Option: Install closet organizers that eliminate clutter and the need to |
| | bend down or reach up for items. |
| □ | Recommendation for best practice: Widen doorways into bedroom |
| | and bathroom. Bathroom doors are 36″ width min. and |
| | open out of interior space for safety. |
| □ | Note: If the door must swing into the bathroom, “break-away” |
| | hardware should be used. (In-swinging doors pose a potential danger |
| | should the wheelchair user or client fall and block the door). |
| □ | Recommendation: All doors should allow a clear area of at least |
| | 18″ in width adjacent to the door on the opposite side of the hinges. |
| □ | Option: Pocket doors to minimize barriers |
| □ | Option: Best practice - situate the bed so there is at least 36-inches of |
| | clearance to allow for wheelchair approach. |
| □ | Option: Include an exercise room near the master bedroom-bath |
| □ | Option: Design bathrooms that are fun to lounge in, bath in and |
| | steam in. |
| □ | Option: Create a suite (bedroom and private bath) for guest or |
| | caregiver |
| □ | Recommendation and best practice: Mirror visible from both sitting & |
| | standing positions. Mirrors should be tilted or lowered to |
| | accommodate the client. The bottom edge of a flat mirror should be |
| | no higher than 36-inches off the floor. |
| □ | Bathing and shower mats |
| □ | Safety mat |
| □ | Cushioned mat |
| □ | Safety strips |
| | Hall bathroom, guest bathroom |
| □ | Set up a bedroom designated for a care-giver/live-in |
| □ | Toilets height: Elongated - 14.5–16″ 16 17.5″ 17–19″ - Approach: |
| | Clear floor space 30″ × 48″ for forward approach. |
| □ | Recommendation: Toilet paper dispenser is installed 20″ to 24″ high |
| | and is within easy reach. |
| □ | Recommendation: Solid blocking for grab bars is best for installation. |
| □ | Option: Install a wall hung toilet for increased access. |
| □ | Option: Self-flushing toilet |
| □ | Recommendation and Best Practice. A vanity offers an attractive |
| | functional alternative to the lavatory - it is necessary to |
| | provide adequate knee space below the basin |
| □ | Note: Vanity height should not exceed 34″. The knee space below the |
| | vanity should have a minimum height of 27″ and a minimum width |
| | of 36″. Vanity tops should be approximately 27″ deep and the |
| | faucet located at a maximum distance of 21″ from the edge of |
| | the vanity. |
| □ | Faucets and Bath Fixtures: |
| □ | Recommendation and best practice: Insulate hot water pipes. All |
| | exposed water supply and drain lines must be insulated to |
| | prevent burns and scrapes. |
| □ | Recommendation and Best Practice: Install a pressure balanced, anti- |
| | scald value or thermostatically controlled value will prevent |
| | accidental burns. |
| □ | Tub and Shower controls: |
| □ | Recommended: Hand-held shower head on adjustable track with |
| | on/off/ pause water control and min. of 60″. Option and Best Choice |
| | is 70″ to 80″ of hose. |
| □ | Option: Locate shower controls near the shower seat for accessibility. |
| □ | Note: A shower stall should be flush with the wall. Avoid using a |
| | ramp or any vertical rise (a shower commode chair with rubber |
| | tires will have difficulty navigating a vertical rise of even |
| | ¼ inch. |
| □ | Option: Shower curtain or door - maintain open space and eliminate |
| | barriers. |
| □ | Recommended: Install towel bars and dispensers 40″ from floor or |
| | less. |
| □ | Plumbing controls: Single levered or automatic. Controls easily |
| | operated with one hand with 5 lbs force or less. Equip the |
| | faucets with scald guards. |
| □ | Kohler - www.kohler.com |
| □ | Alson - www.alsons.com |
| □ | Jaclo - www.Jaclo.com |
| □ | Grab bars |
| □ | Towel bars |
| □ | Non-skid floors |
| □ | Electrical: GFI electrical outlet near sink. |
| □ | Lighting: Non-glare |
| □ | Switches: 36–48″ above floor |
| □ | Outlets: 15″ to 24″ above floor |
| □ | Telephone jacks 18″ to 24″ H |
| □ | Vanity sink: See Kohler Invitation series (Cashmere) The |
| | self-rimming, sloping sink is designed to extend beyond the edge of |
| | the countertop for access without reaching. Shallow depth |
| | w/plumbing installed to the rear of the sink: eliminate sharp edges. |
| □ | Knee space: Recommend 19″–26″ allowed under open bottom sink. |
| □ | Bathroom door open out |
| □ | Recommendation and best practice: Mirror visible from both sitting |
| | and standing positions. |
| □ | Wheelchair can roll up to counter, sink, vanity with adequate counter |
| | space |
| □ | Anti-scald device on faucet and shower diverter |
| □ | Space to maneuver wheelchair next to toilet 30″ to preferred 42″ |
| □ | Option: Install bath lift |
| □ | Option: Add a transfer bench |
| □ | Option: Add a shower chair |

Utility Room/Laundry

| | |
|---|---|
| □ | Note-Replace basement laundry rooms - move upstairs on a ground |
| | floor or existing bathroom, or a utility closet if possible, use |
| | stack compact washer/dryers. Prefer front loaders that are raised up |
| | on pedestals for more universal access due to inability to reach |
| | stacking components with age |
| □ | Option: Front-load washing/dryers for clients in wheelchairs or with |
| | functional mobility issues. Appliance controls should be located |
| | on the front. |

Office
□
Flex Room

| | |
|---|---|
| □ | The flex room can be utilized at different seasons of need. It can |
| | be used for a nursery or playroom when the children are young or |
| | as an office later. If combined with a full bath, this room could |
| | also be used for and aging parent or respite area. |

Evaluation for Telehealth/Medicine

| | |
|---|---|
| □ | First floor or ground floor of home |
| □ | Modify an existing dining room for |
| □ | Oxygen tanks or oxygen machine |
| □ | Extra electrical for equipment |
| □ | Run co-x cable for cable or Dish TV |
| □ | Monitored medication location |
| □ | Best location and recommendation |
| □ | Mini refrigerator for medications |
| □ | Scales |
| □ | Telehealth machine w/hard wire phone line |
| □ | Ability to independently or with assist utilize equipment and safe |
| | access to equipment (i.e., to step on scale independently without |
| | risk of fall etc) |
| □ | If O2 if used in home, what is the path of the tubing. Is there |
| | anyone at risk of falls due to the location of the tubing. Can the |
| | tubing be marked or trailed along the wall vs. the floor |
| □ | Option: For those using electrical devices, make sure an adequate |
| | power supply and ample room for the devices are available. |
| □ | Option: Install sensors (see Lutron at www.lutron.com) or other |
| | mechanism that automatically turns lights on when a door is |
| | opened in a bathroom, kitchen, bedroom or stairwell |

Flooring

| | |
|---|---|
| □ | Recommendation: Use low pile, high density carpet in appropriate |
| | locations. |
| □ | Note: In addition to its aesthetic qualities, carpet greatly reduces |
| | sound transmission and serves to cushion falls. |
| □ | Note: Avoid loose weave carpets or shag rugs as it makes travel |
| | difficult for ambulants and wheelchair users |
| □ | Eliminate soft padding under carpet. Recommendation: Use a hard |
| | commercial padding gives a more surefooted surface. |
| □ | Option: smooth surface floors such as wood floors |
| □ | Option: smooth surface floors such as Cork flooring |
| □ | Add short-piled carpet to prevent tripping and ease for wheel chair |
| | use. |
| □ | Note: avoid thick, soft padding. |

Storage Areas
Communication
Falls Prevention

| | |
|---|---|
| □ | Safety in the Home |
| □ | Recommendation: Eliminate throw or area rugs that may slip when |
| | stepped on. |
| □ | Recommendation: Eliminate any exposed cords or cables to prevents |
| | falls |
| □ | Recommendation: Pet Care |
| □ | Falls linked to deficiency in the immediate environment with |
| | improper or inadequate lighting |

Elevator

| | |
|---|---|
| □ | Install an elevator or stair lift |
| □ | Recommendation: Multi-story homes may provide either pre-framed |
| | shafts (Stacked closets) for a future elevator or stairway width |
| | must be a minimum of 4′ to allow space for the lift. |

Grab Bars or Railings

| | |
|---|---|
| □ | Recommendation and best practice: Install support grab bars in the |
| | bathroom, especially in the tub and shower and beside the toilet, |
| | and in other areas as deemed necessary by the OT evaluation to |
| | assist with stability and sitting and standing. |
| □ | Advanced planning will be necessary to determine on which side |
| | of the toilet a folding grab bar will be place - eval by OT |
| □ | Types of grab bars: |
| □ | Wall-Mounted: |
| □ | Floor or ceiling Mounted: |
| □ | Folding Bars: |
| □ | Portable Bars: |
| □ | Option to install: 1½″ inch stainless finish bar |
| | 12″ 18″ 24″ 36″ 42″ 48″ |
| □ | Option to install 1¼″ inch stainless finish bar |
| | 12″ 18″ 24″ 36″ 42″ 48″ |
| □ | Powder coated - grab bar |
| □ | Textured - grab bar |
| □ | Recommended: Wingit's grab bar fastening system |
| □ | Slip resistant ripples - grab bar |
| □ | Angled Grab bars |
| □ | Inside corner grab bar |
| □ | Wall mounted support rail @ toilet area |
| □ | OT/PT recommendation to evaluate homeowner or client for the |
| | proper diameter and height |
| □ | OT/PT recommendation to evaluate homeowner or client for the |
| | proper ceiling mounted railing systems |
| □ | OT/PT recommendation to evaluate homeowner or client for the |
| | proper stair glides or sling |
| □ | Reduce the likelihood of falls - add grab bars |

Door Hardware

| | |
|---|---|
| □ | Option: Install doorknob lever gripper |
| □ | Levered rubber doorknob extensions |
| □ | Levered handles |
| □ | Automatic door openers |

Smoke/Alarms - Detectors

| | |
|---|---|
| □ | Appliances that run on oil, kerosene, propane, natural gas, wood, |
| | coal, or gasoline are problem sources or Carbon Monoxide |
| □ | Recommendation: Install a combo smoke alarm & carbon monoxide |
| | detector |
| □ | Option: Add a Kidde wireless interconnected smoke alarm system |
| □ | Recommendation and Best Practice: Install audible and visual strobe |
| | light system to indicate when the doorbell, telephone, or smoke |
| | or CO2 detectors have been activated. |
| □ | Bed-shaking alarms |

Emergency Evacuation and Preparedness

| | |
|---|---|
| □ | Preparedness: |
| □ | In spite of your best planning, sometimes a personal support network |
| | must be created on the spot. For example you may find yourself in a |
| | shelter and needing to assemble help for immediate assistance. Think |
| | about what you will need, how you want it done and what kind of |
| | person you would select. Prepare copies of your relevant emergency |
| | documents, house insurance agent, papers on the house, health |
| | insurance, term life or whole life insurance, shot records, auto |
| | insurance, accountant, stock broker, professional contacts, will, |
| | tax returns, real estate deeds, insurance policies, pre-paid funeral |
| | arrangements, details you wish to have observed, list of family and |
| | friends, emergency health information card. Place all copies |
| | in a water proof container. (Marine tool kits are a good example |
| | available at sporting good stores or sections of dept. stores) |
| | Organize each separate category (home, medical, vehicle etc) by large |
| | ziplock freezer bags to seals contents individually. |
| □ | Prepare a list of all medical information. |
| □ | Have extra medications available |
| □ | Have extra medication prescriptions |
| □ | Know all your doctors emergency contact information |
| □ | Emergency Evacuation: |
| □ | Smoke Alarms are law |
| □ | Check batteries monthly |
| □ | Place one on each floor, near stairwells, and near bedrooms |
| □ | Escape Plan: |
| □ | Make sure there are two exits out |
| □ | Designate a meeting place to go in case of an emergency or fire |

Low Vision

| | |
|---|---|
| □ | The quantity and quality of lighting in design is especially |
| | important for persons with low-vision |
| □ | Proper installation of under cabinet lighting to reduce glare |
| □ | Task lighting |
| □ | Color contrasting/use of a brighter color palette |
| □ | Color perception is altered with aging, thus focus on contrast |
| | surfaces and lighting. |
| □ | Increase bulb wattage, if needed. Verify that selected lamps are |
| | rated to accommodate higher wattage. Avoid halogen |

TABLE 2

| | |
|---|---|
| I. | Pre-programmed diseases, impairments, and disabilities |

| | |
|---|---|
| A. | Arthritis |
| B. | Alzheimer's |
| C. | Amputation |
| D. | Dementia |
| E. | Diabetes |
| F. | Heart Disease |
| G. | Juvenile |
| H. | Joint Replacement |
| I. | Low Vision/Blindness |
| J. | Paralysis/Paralyzed |
| K. | Parkinson's |
| L. | At Risks for Falls |
| M. | Range of Motion |
| N. | Stroke |
| O. | Ability to Perform ADL's |

| | |
|---|---|
| II. | Designate Disease, Impairment, or Disability |

| | |
|---|---|
| A. | Alzheimer's |
| B. | Designated Area of Home Desired to be Modified |

| | |
|---|---|
| 1. | Bathroom |

| | |
|---|---|
| C. | Generate Recommendation |

| | |
|---|---|
| 1. | Modification |

| | |
|---|---|
| a. | Sink - Install anti-scald faucet value |

| | |
|---|---|
| 2. | Product |

| | |
|---|---|
| a. | Kolher EA 1354 |

While preferred embodiments of the present invention have been described, it is to be understood that the embodiments described are illustrative only and that the scope of the invention is to be defined solely by the appended claims when accorded a full range of equivalence, many variations and modifications naturally occurring to those skilled in the art from a perusal hereof.

What is claimed is:

1. A method of recommending a modification to a residential property that is intended to satisfy a need of an occupant of said residential property, comprising the steps of:
(a) evaluating and collecting data about accessibility, safety, and functionality of said residential property;
(b) evaluating and collecting data about current and projected future physical capabilities and medical health of said occupant;
(c) inputting all of said collected data into a computer program;
(d) causing said computer program to generate a recommendation to modify said residential property in response to said inputted collected data, said recommendation intended to satisfy said need of said occupant;
wherein said need of said occupant includes independence, safety, quality of life, aging-in-place initiatives, or any combination thereof.

2. The method according to claim 1, wherein said data about said accessibility of said residential property includes information about environmental barriers preventing or restricting said occupant from maneuvering within said residential property.

3. The method according to claim 1, wherein said data about said safety of said residential property includes information about the ability of said occupant to perform functional tasks within said residential property without causing harm to said occupant, said occupant being a resident of said residential property or a care giver providing assistance to said resident.

4. The method according to claim 1, wherein said data about said functionality of said residential property includes information about a physical environment of said residential property and an ability of said occupant to effectively use said physical environment.

5. The method according to claim 4, wherein said physical environment includes structure; accessibility to said structure; floor plan; accessible pathways; appliances; major mechanical and environmental equipment; furniture; lighting and plumbing fixtures; floors; walls; ceiling; doors; windows; cabinets and countertops; flooring; or any combination thereof.

6. The method according to claim 1, wherein said evaluation and collection of data about said accessibility, safety, and functionality of said residential property are undertaken by a certified aging-in-place specialist, a licensed medical professional, or both.

7. The method according to claim 6, wherein said certified aging-in-place specialist is selected from the group consisting of a professional remodelor, a licensed contractor, a licensed medical professional, a licensed interior designer, and a licensed professional involved with housing for disabilities, products, accessibility, and aging.

8. The method according to claim 6, wherein said licensed medical professional is selected from the group consisting of an occupational therapist, an occupational therapist assistant, a physical therapist, a physical therapist assistant, a registered nurse, and a license practical nurse.

9. The method according to claim 1, wherein said evaluation and collection of data about said current and projected future physical capabilities and medical health of said occupant are undertaken by a licensed medical professional.

10. The method according to claim 9, wherein said licensed medical professional is selected from the group consisting of an occupational therapist, an occupational therapist assistant, a physical therapist, a physical therapist assistant, a registered nurse, and a license practical nurse.

11. The method according to claim 1, wherein said residential property includes a residence having an interior and an exterior and a grounds surrounding said residence and wherein said data collected about said accessibility, safety, and functionality of said residential property includes data collected about said interior, said exterior, said grounds, or any combination thereof.

12. The method according to claim 11, wherein said data collected about said accessibility, safety, and functionality of said interior of said residence includes information about primary entrance doors; foyers; hallways; living rooms; dining rooms; interior stairs including stairs to basement, upper levels, and attic; ramps; lifts; elevators; windows; decks; balconies; porches; Heating/Venting/Air Conditioning (HVAC); kitchens; cabinets and countertops; appliances; bedrooms; separate apartments; offices; flex rooms such as mini-hospital rooms; hall and guest bathrooms; master bathrooms; entertainment rooms; family rooms; dens; bath tubs; showers; vanities; utility, laundry and mudrooms; storage; storage areas; trashcans; grab bars and railings; flooring; pathways to all areas; space planning; house plans and designs; steps; split levels; stairwells; personal emergency responses; electrical, lighting, safety and security, environmental controls; storage; heights of breaker/fuse boxes; garage, car port and boarding spaces; surfaces and flooring in garage, car port, and boarding spaces; utility, laundry, mudroom and bathroom cabinets; closets; convenience features such as central vacuum, built-in pet feeder, built-in recycling system, video phone or camera, and intercom system; width of hallways and doorways; doors, hardware, and cabinet fixtures; plumbing faucet and fixtures; basement and attic accessibility; lighting; colors and contrasts for walls, finishes, and insulation; emergency escape routes; or any combination thereof.

13. The method according to claim 11, wherein said data collected about said accessibility, safety, and functionality of said exterior of said residence includes information about protected or covered entryways, sidewalks, steps, porches, decks, handrails, hardware, ramps, exterior lighting, emergency response systems, or any combination thereof.

14. The method according to claim 11, wherein said data collected about said accessibility, safety, and functionality of said grounds of said residential property includes information about parking, walkways, driveways, gardens, pathways, seating areas, lighting, maintenance, security, storage sheds or outbuildings, irrigation, landscaping, swimming pools, patio furniture, outdoor kitchens, accessible routes, mailboxes or mail chutes, surfaces, steps, railways, ramps, lifts, or any combination thereof.

15. The method according to claim 1, wherein said data collected about said current and projected future physical capabilities and medical health of said occupant includes information about age; medical history; functional tasks; functional mobility; medication use including use of diuretics, narcotics, and pain relievers; hand dexterity; fall prevention; range of motion; sensory skills; endurance; mental health; progression of disease; vision; hearing; cognitive ability; olfactory capabilities; balance; strength; functional communication; or any combination thereof.

16. The method according to claim 1, wherein said data collected about said accessibility, safety, and functionality of said residential property includes a visual presentation.

17. The method according to claim 16, wherein said visual presentation is a digital photograph or a digital video.

18. The method according to claim 1, wherein said recommendation to modify said residential property includes a phased design providing for future modifications intended to satisfy a long-term need of said occupant, said long-term need including safety, independence, quality of life, aging-in-place initiatives, or any combination thereof.

19. The method according to claim 1, wherein said recommendation to modify said residential property includes a physical modification.

20. The method according to claim 19, wherein said physical modification includes adding, removing or modifying pathways; landscaping; gardens; mailboxes; trashcan placement areas; surfaces; entranceways; hallways; ramps; stairs; porches; decks; split levels; lifts; cabinets; appliances; furniture; lighting; wall and cabinet colors; flooring; controls for lighting, heating, venting, air conditioning, disposals; toilets; fixtures for plumbing and faucets; sinks; tubs; showers; bidets; bedrooms; storage areas; communication devices; a tele-health and tele-medicine area or room; mini-hospital room; elevators; grab bars; railings; door hardware; smoke and alarm detectors; or any combination thereof.

21. The method according to claim 19, wherein said recommendation to modify said residential property includes identifying a product to be incorporated into said residential property as part of said physical modification.

22. The method according to claim 21, wherein said product is a pathway surface; light fixture; photo sensor; mailbox; ramp; lift; cabinet; appliance; furniture; flooring; carpeting; contrast surfaces; controls for lighting, heating, venting air conditioning, or disposal; electric outlet; toilet; fixtures for plumbing and faucets; sink; tub; shower; bidet; bedroom, office cabinets or equipment; storage area; shelving for garden tools; tele-health or tele-medicine area or room; mini-hospital equipment; elevator; grab bar; railing; door hardware; or smoke or alarm detector.

23. The method according to claim 1, wherein said recommendation to modify said residential property includes identifying a product to be used by said occupant.

24. The method according to claim 23, wherein said product is a communication device; utensil; wheel chair; power chair; transfer board; hoyer lift; trapeze bar; walker; cane; vertical support pole; grab bar; oxygen tank or machine; care monitoring system; home entertainment system; emergency preparedness container, or other durable medical equipment product.

25. The method according to claim 1, wherein said recommendation to modify said residential property includes a visual presentation.

26. The method according to claim 25, wherein said visual presentation is a digital photograph or a digital video.

27. The method according to claim 1, wherein said occupant is a resident of said residential property, a care giver providing assistance to said resident, or an owner of said residential property.

28. The method according to claim 1, wherein said computer program is part of a wide area network accessible by a secured Internet connection.

29. The method according to claim 28, wherein said wide area network is a wide area wireless network.

30. The method according to claim 29, wherein all of said collected data is inputted into said computer program using a remote device.

31. The method according to claim 30, wherein said remote device is a lap top computer, a tablet computer, or a hand-held computer.

32. The method according to claim 30, wherein said remote device is operated by a stylus, said stylus being used to input said collected data into said computer program.

33. The method according to claim 30, further comprising the step of presenting said recommendation to modify said residential property to said occupant by displaying said recommendation on said remote device.

34. The method according to claim 33, further comprising the step of transmitting said recommendation to modify said residential property to a third-person.

35. The method according to claim 34, wherein said third-person is a contractor, a subcontractor, a health care professional, immediate family member or designated contact person for said occupant, an insurance carrier, or a government agency.

36. The method according to claim 30, further comprising the step of presenting said recommendation to modify said residential property to said occupant by printing a paper copy of said recommendation and displaying said paper copy to said occupant.

37. The method according to claim 1, further comprising the steps of:
(e) obtaining a laser beam measurement of said residential property;
(f) inputting said laser bean measurement into said computer program to generate a floor plan for said residential property;
wherein said measurement and said floor plan constitute part of said recommendation to modify said residential property.

38. The method according to claim 1, further comprising the step of inputting a further recommendation to modify said residential property directly into said computer program.

39. The method according to claim 38, wherein said further recommendation is inputted into said computer program via word processing, writing capture, or voice capture.

40. The method according to claim 11, wherein said residence is a single-family home, a multi-family home, an assisted-living facility, or a nursing home.

41. The method according to claim 1, further comprising the step of causing said computer program to generate a clinical recommendation for therapeutic intervention of said occupant.

42. The method according to claim 41, wherein said clinical recommendation includes a recommendation for a physical therapy protocol, a recommendation to schedule an appointment with a primary care physician for an evaluation, or both.

43. The method according to claim 1, wherein said collected data inputted into said computer program and said recommendation generated by said computer program to modify said residential property are capable of being searched and retrieved.

44. The method according to claim 43, wherein said search and retrieval of said collected data inputted into said computer program and said recommendation generated by said computer program to modify said residential property are conducted by searching a database of said computer program using a search facilitator, said search facilitator including a key word, a category of information, a 3-D floor plan, or any combination thereof.

45. The method according to claim 1, wherein said computer program includes screen prompts for data to be collected about said accessibility, safety, and functionality of said residential property and for data to be collected about said current and projected future medical health of said occupant, and wherein said screens prompts are used to collect and input said data into said computer program.

46. The method according to claim 1, wherein said recommendation to modify said residential property includes an option to modify said residential property that is generated in response to designating a specific disease, impairment, or disability of said occupant within said computer program.

47. The method according to claim 46, wherein said specific disease, impairment or disability is selected from the group consisting of Arthritis, Alzheimer's, Amputation, Dementia, Diabetes, Heart Disease, Joint Replacement, Low Vision or Blindness, Paralysis, Parkinson's, Stroke, Risk of Falls, Range of Motion, Multiple Sclerosis, and Down's Syndrome.

48. A method of recommending a modification to a commercial property that is intended to satisfy a need of an occupant of said commercial property, comprising the steps of:
(a) evaluating and collecting data about accessibility, safety, and functionality of said commercial property;
(b) inputting said collected data into a computer program;
(c) causing said computer program to generate a recommendation to modify said commercial property in response to said inputted collected data, said recommendation intended to satisfy said need of said occupant;
wherein said need of said occupant includes independence, safety, quality of life, or any combination thereof.

49. The method according to claim 48, wherein said evaluation and collection of data about said accessibility, safety, and functionality of said commercial property are undertaken by a certified aging-in-place specialist, a licensed medical professional, or both.

50. The method according to claim 49, wherein said certified aging-in-place specialist is selected from the group consisting of a professional remodelor, a licensed contractor, a licensed interior designer, and a licensed professional involved with housing for disabilities, products, accessibility, and aging.

51. The method according to claim 49, wherein said licensed medical professional is selected from the group consisting of an occupational therapist, an occupational therapist assistant, a physical therapist, a physical therapist assistant, a registered nurse, and a licensed practical nurse.

52. The method according to claim 48, further comprising the step of:
(d) evaluating and collecting data about current and projected future physical capabilities and medical health of said occupant;
(e) inputting said data collected in step (d) into said computer program; and
(f) causing said computer program to generate a recommendation to modify said commercial property in response to said data inputted into said computer program in step (e), said recommendation intended to satisfy said need of said occupant.

53. The method according to claim 52, wherein said evaluation and collection of data about said current and projected future physical capabilities and medical health of said occupant are undertaken by a licensed medical professional.

54. The method according to claim 53, wherein said licensed medical professional is selected from the group consisting of an occupational therapist, an occupational therapist assistant, a physical therapist, a physical therapist assistant, a registered nurse, and a licensed practical nurse.

55. The method according to claim 52, wherein said data collected about said current and projected future physical capabilities and medical health of said occupant includes information about age; medical history; functional tasks; functional mobility; medication use including use of diuretics, narcotics, and pain relievers; hand dexterity; fall prevention; range of motion; sensory skills; endurance; mental health; progression of disease; vision; hearing; cognitive ability; olfactory capabilities; balance; strength; functional communication; or any combination thereof.

56. The method according to claim 48, wherein said data about said accessibility, safety, and functionality of said commercial property includes information about needs for alterations, additions, program accessibility, essential and non-essential job functions, cosmetic work, maintenance repairs, transitions, specialized equipment, products or information, renovation, remodel modifications, targeting existing problem areas or architectural inefficiencies, plan review to eliminate costly structural changes or endorse specialized modifications for safety, prolonging the independence in the work place, quality of work styles, rearranging existing work spaces, or any combination thereof.

57. The method according to claim 48, wherein said data about accessibility, safety, and functionality of said commercial property includes information about continuous path of travel, surface material, slope and cross-slope, curb ramp design and locations, on-street parking, alternate circulation path, islands and medians, pedestrian button location and design, accessibility of pedestrian signals, street or patio furniture style, access and placement; drinking fountains, illumination of pathways, handrails, parking spaces; warning for hearing impaired including clear signage, symbols and pictograms, clear sightlines, audible information systems louder than ambient surrounding noise; existing barriers and list physical barriers that limit accessibility, programs, activities, or services; warning for low vision including hazards of protruding objects, symbols and pictograms, blended curbs, detectable warnings, audible information systems, tactical information systems, visual contrast at steps, visual cues, wall mounts and post mounted objects; adequate shelter from weather in passenger unloading zone; entrance ramps and hand rails; width of doorways, door openers, electronic pad for security card entry, special access lifts; unobstructed routes through facility; accessible restrooms including slippery walking or hygiene issues insufficient maneuvering area, controls, toilet height, stall width, grab bar combinations, inadequate storage shelf in stall and or inaccessible places, door landings, latch side clearance, signage to identify permanent rooms and space, lighting, faucets, bank of telephones, or any combination thereof.

58. The method according to claim 48, wherein said recommendation to modify said commercial property includes a recommendation for accessibility by developing guidelines for new or altered facilities covered under the Americans with Disabilities Act or the Architectural Barrier Act.

59. The method according to claim 48, wherein said need of said occupant intended to be satisfied by said recommendation to modify said commercial property includes enhancement of said occupants accessibility, elimination of obstacles for community involvement, improvement of work place ergonomics for increasing quality of work styles, promotion of environmental harmony in designing for accessible communities, or any combination thereof.

60. The method according to claim 48, wherein said data collected about said accessibility, safety, and functionality of said commercial property includes a visual presentation.

61. The method according to claim 60, wherein said visual presentation is a digital photograph or a digital video.

62. The method according to claim 48, wherein said recommendation to modify said commercial property includes a physical modification.

63. The method according to claim 62, wherein said recommendation to modify said commercial property includes identifying a product to be incorporated into said commercial property as part of said physical modification.

64. The method according to claim 48, wherein said recommendation to modify said commercial property includes identifying a product to be used by said occupant.

65. The method according to claim 48, wherein said recommendation to modify said commercial property includes a visual presentation.

66. The method according to claim 65, wherein said visual presentation is a digital photograph or a digital video.

67. The method according to claim 48 wherein said occupant is an invitee, an employee, an owner of said commercial property, or a legal representative of said owner.

68. The method according to claim 48, wherein said computer program is part of a wide area network accessible by a secured Internet connection.

69. The method according to claim 68, wherein said wide area network is a wide area wireless network.

70. The method according to claim 69, wherein said collected data is inputted into said computer program using a remote device.

71. The method according to claim 70, wherein said remote device is a lap top computer, a tablet computer, or a hand-held computer.

72. The method according to claim 70, wherein said remote device is operated by a stylus, said stylus being used to input said collected data into said computer program.

73. The method according to claim 70, further comprising the step of presenting said recommendation to modify said commercial property to said occupant by displaying said recommendation on said remote device.

74. The method according to claim 73, further comprising the step of transmitting said recommendation to modify said commercial property to a third-person.

75. The method according to claim 74, wherein said third-person is a contractor, a subcontractor, a health care professional, a designated contact person for said occupant, an insurance carrier, or a government agency.

76. The method according to claim 70, further comprising the step of presenting said recommendation to modify said commercial property to said occupant by printing a paper copy of said recommendation and displaying said paper copy to said occupant.

77. The method according to claim 48, further comprising the steps of:
(d) obtaining a laser beam measurement of said commercial property;
(e) inputting said laser bean measurement into said computer program to generate a floor plan for said commercial property;
wherein said measurement and said floor plan constitute part of said recommendation to modify said commercial property.

78. The method according to claim 48, further comprising the step of inputting a further recommendation to modify said commercial property directly into said computer program.

79. The method according to claim 78, wherein said further recommendation is inputted into said computer program via word processing, writing capture, or voice capture.

80. The method according to claim 48, wherein said commercial property is an office building; a public or private school, university, or college; a medical professional building; a restaurant; a hotel; a motel; a commercial facility; a resort; a VA, public or private hospital; a rehabilitation center; or an independent living center.

81. The method according to claim 48, wherein said collected data inputted into said computer program and said recommendation generated by said computer program to modify said commercial property are capable of being searched and retrieved.

82. The method according to claim 81, wherein said search and retrieval of said collected data inputted into said computer program and said recommendation generated by said computer program to modify said commercial property are conducted by searching a database of said computer program using a search facilitator, said search facilitator including a key word, a category of information, a 3-D floor plan, or any combination thereof.

83. The method according to claim 48, wherein said computer program includes screen prompts for data to be collected about said accessibility, safety, and functionality of said commercial property and wherein said screen prompts are used to collect and input said data into said computer program.
